(19) United States
(12) Patent Application Publication
(10) Pub. No.: US 2026/0267421 A1
(43) Pub. Date: Sep. 10, 2026

(54) ELECTRONIC DEVICE AND METHOD FOR OPERATING THEREOF AND STORAGE MEDIUM

(71) Applicant: SAMSUNG ELECTRONICS CO., LTD., Suwon-si (KR)

(72) Inventors: Seungbin OH, Suwon-si (KR); Donghun Kang, Suwon-si (KR); Sangyoon Lee, Suwon-si (KR); Dahye Shim, Suwon-si (KR); Sooah Kim, Suwon-si (KR); Soyoung Yun, Suwon-si (KR)

(73) Assignee: SAMSUNG ELECTRONICS CO., LTD., Suwon-si (KR)

(21) Appl. No.: 19/652,065

(22) Filed: Apr. 20, 2026

Related U.S. Application Data
(63) Continuation of application No. PCT/KR2026/002316, filed on Feb. 6, 2026.

(30) Foreign Application Priority Data
Mar. 7, 2025 (KR) 10-2025-0029553

(51) Int. Cl. G06F 3/01; H04N 9/31

(52) U.S. Cl. CPC G06F 3/017; H04N 9/3185; H04N 9/3114; H04N 9/3161

(57) ABSTRACT

An electronic apparatus including a communication circuit; a projector; at least one processor including processing circuitry; and memory storing one or more instructions. The one or more instructions, when executed individually or collectively by the at least one processor, cause the electronic apparatus to, based on first gesture information of a user being obtained through the communication circuit, identify a second content corresponding to the first gesture information based on a first content provided through a first external device of at least one external device, and display, based on a first projection region associated with the first external device being identified from among at least one projectable region based on environment information corresponding to a projection space, the second content at the first projection region through the projector.

### CROSS-REFERENCE TO RELATED APPLICATIONS

This application is a continuation application, claiming priority under 35 U.S.C. § 365(c), of an International application No. PCT/KR2026/002316, filed on Feb. 6, 2026, which is based on and claims the benefit of a Korean patent application number 10-2025-0029553, filed on Mar. 7, 2025, in the Korean Intellectual Property Office, the disclosure of which is incorporated by reference herein in its entirety.

### BACKGROUND

### 1. Field

The disclosure relates to an electronic apparatus and a method for operating thereof and a storage medium, and more particularly to an electronic apparatus that provides content to users and a method for operating thereof and a storage medium.

### 2. Description of Related Art

Electronic devices of various types are being developed and supplied with the development of electronic technology, and recently, an electronic apparatus (e.g., projector) that provides images to users are being developed. The electronic apparatus may provide various information by providing images to users. For example, a projector may provide images to users by projecting light in a designated space. The projector may mean an electronic apparatus that forms an image on a projection surface by projecting light onto the projection surface (or screen).

### SUMMARY

According to an aspect of the disclosure, an electronic apparatus including a communication circuit; a projector; at least one processor including processing circuitry; and memory storing one or more instructions. The one or more instructions, when executed individually or collectively by the at least one processor, cause the electronic apparatus to, based on first gesture information of a user being obtained through the communication circuit, identify a second content corresponding to the first gesture information based on a first content provided through a first external device of at least one external device, and display, based on a first projection region associated with the first external device being identified from among at least one projectable region based on environment information corresponding to a projection space, the second content at the first projection region through the projector.

According to an aspect of the disclosure, a method for operating an electronic apparatus, includes identifying, based on first gesture information of a user being obtained through a communication circuit of the electronic device, a second content corresponding to the first gesture information based on a first content provided through a first external device of at least one external device; and displaying, based on a first projection region associated with the first external device being identified from among at least one projectable region based on environment information corresponding to a projection space, the second content at the first projection region through a projector of the electronic device.

According to an aspect of the disclosure, a non-transitory computer-readable medium stores one or more instructions, the one or more instructions, when executed by at least one processor of an electronic apparatus, cause the electronic apparatus to, based on first gesture information of a user being obtained, identify a second content corresponding to the first gesture information based on a first content provided through a first external device, and display, based on a first projection region associated with the first external device being identified from among at least one projectable region based on environment information corresponding to a projection space, the second content at the first projection region through a projector of the electronic apparatus.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram schematically illustrating an electronic apparatus according to an embodiment;

FIG. 2 is a block diagram illustrating a configuration of an electronic apparatus according to an embodiment;

FIG. 3 is a flowchart illustrating an operating method of an electronic apparatus according to an embodiment;

FIG. 4A is a flowchart illustrating a method for identifying a second content according to an embodiment;

FIG. 4B is a diagram illustrating a method for identifying a second content according to an embodiment;

FIG. 4C is a diagram illustrating a method for identifying a second content according to an embodiment;

FIG. 4D is a diagram illustrating a method for identifying a second content according to an embodiment;

FIG. 4E is a diagram illustrating a method for identifying a second content according to an embodiment;

FIG. 4F is a diagram illustrating a method for identifying a second content according to an embodiment;

FIG. 4G is a diagram illustrating a method for identifying a second content according to an embodiment;

FIG. 4H is a diagram illustrating a method for identifying a second content according to an embodiment;

FIG. 4I is a diagram illustrating a method for identifying a second content according to an embodiment;

FIG. 4J is a diagram illustrating a method for identifying a second content according to an embodiment;

FIG. 4K is a diagrams illustrating a method for identifying the second content according to an embodiment;

FIG. 5A is a flowchart illustrating a method for displaying a content based on gesture information of a user according to an embodiment;

FIG. 5B is a diagram illustrating a method for displaying content based on gesture information of a user according to an embodiment;

FIG. 5C is a diagram illustrating a method for displaying content based on gesture information of a user according to an embodiment;

FIG. 5D is a diagram illustrating a method for displaying content based on gesture information of a user according to an embodiment;

FIG. 5E is a diagram illustrating a method for displaying content based on gesture information of a user according to an embodiment;

FIG. 5F is a diagram illustrating a method for displaying content based on gesture information of a user according to an embodiment;

FIG. 5G is a diagram illustrating a method for displaying content based on gesture information of a user according to an embodiment;

FIG. 6A is a flowchart illustrating a method for displaying a first content at a third projection region according to an embodiment;

FIG. 6B is a diagram illustrating a method for displaying a first content at a third projection region according to an embodiment;

FIG. 7A is a flowchart illustrating a method for providing a first content according to an embodiment;

FIG. 7B is a diagram illustrating a method for providing a first content through a second external device according to an embodiment;

FIG. 8A is a diagram illustrating a method for providing a second content according to an embodiment;

FIG. 8B is a diagram illustrating a method for providing second content according to an embodiment;

FIG. 8C is a diagram illustrating a method for providing second content according to an embodiment;

FIG. 8D is a diagram illustrating a method for providing second content according to an embodiment;

FIG. 8E is a diagram illustrating a method for providing second content according to an embodiment;

FIG. 8F is a diagram illustrating a method for providing second content according to an embodiment;

FIG. 9A is a flowchart illustrating a method for displaying a third content according to an embodiment;

FIG. 9B is a diagram illustrating a method for displaying a third content according to an embodiment;

FIG. 9C is a diagram illustrating a method for displaying a third content according to an embodiment;

FIG. 9D is a diagram illustrating a method for displaying a third content according to an embodiment;

FIG. 9E is a diagram illustrating a method for displaying a third content according to an embodiment;

FIG. 9F is a diagram illustrating a method for displaying a third content according to an embodiment;

FIG. 9G is a diagram illustrating a method for displaying a third content according to an embodiment;

FIG. 10A is a flowchart illustrating a method for identifying a fourth projection region according to an embodiment;

FIG. 10B is a diagram illustrating a method for identifying a fourth projection region according to an embodiment;

FIG. 10C is a diagram illustrating a method for identifying a fourth projection region according to an embodiment;

FIG. 10D is a diagram illustrating a method for identifying a fourth projection region according to an embodiment;

FIG. 10E is a diagram illustrating a method for identifying a fourth projection region according to an embodiment;

FIG. 11A is a flowchart illustrating a method for displaying a fourth content according to an embodiment;

FIG. 11B is a diagram illustrating a method for displaying a fourth content according to an embodiment;

FIG. 11C is a diagram illustrating a method for displaying a fourth content according to an embodiment; and

FIG. 12 is a block diagram illustrating a detailed configuration of an electronic apparatus according to an embodiment.

### DETAILED DESCRIPTION

The disclosure will be described in detail below with reference to the accompanying drawings.

Terms used in the disclosure will be briefly described, and the disclosure will be described in detail.

The terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the relevant description. Accordingly, the terms used herein are not to be understood simply as its designation but based on the meaning of the term and the overall context of the disclosure,

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression “at least one of A or B” is to be understood as indicating any one of “A” or “B” or “A and B”.

As used herein, the terms “1st” or “first” and “2nd” or “second” may use corresponding components regardless of importance or order and are used to distinguish one component from another without limiting the components.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

Further, in the disclosure, the term “signal” may include not only electrical signals but also signals in a sound wave form, and electrical signals may include not only analog signals but also digital signals. For example, the expression ‘audio signal (or noise signal)’ may mean sound wave (or radio waves) signals if the relevant signals are outside of an electronic apparatus according the position thereof, and may mean electrical signals if inside of the electronic apparatus. In addition, signal processing and the like in the electronic apparatus which will be described below may involve a method that not only processes signals in a digital method, but also processes signals in an analog method or processes signals using a mix of the analog method and the digital method.

Further, in the disclosure, the term “filter” may be for removing a specific component (e.g., a specific frequency region or a specific pattern), and the relevant filter may be a digital filter or an analog filter.

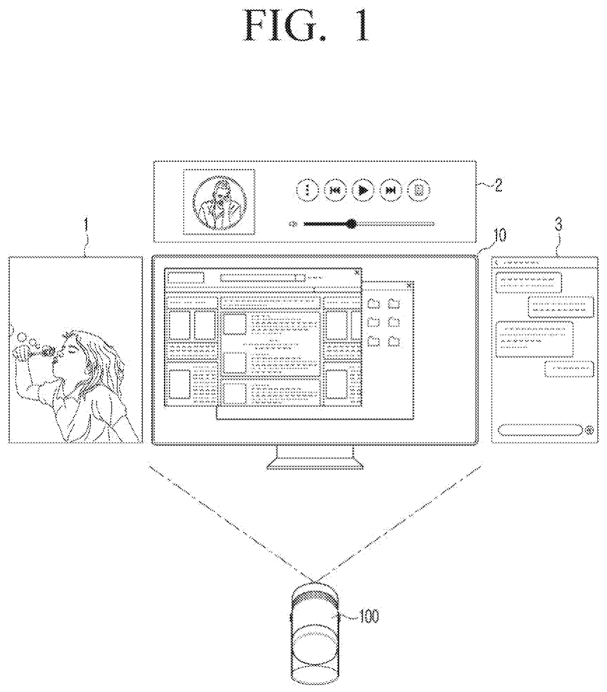

FIG. 1 is a diagram schematically illustrating an electronic apparatus according to an embodiment.

Referring to FIG. 1, according to an embodiment, the electronic apparatus may obtain gesture information of a user. According to an embodiment, the electronic apparatus may identify, based on gesture information being obtained, second content corresponding to the gesture information based on a first content provided through an external device. According to an example, the second content may be the first content or at least a portion of the first content, but is not limited thereto. According to an example, the second content may be obtained from the external device or a user terminal, but is not limited thereto.

According to an embodiment, the electronic apparatus may identify, based on environment information corresponding to a projection space, a projection region associated with an external device from among at least one projectable region. According to an example, the projectable region may be one region in the projection space without an object or without refraction of a projection light. According to an example, the projection region may be a projectable region positioned within a pre-set distance from an electronic device that includes a display.

According to an embodiment, the electronic apparatus may provide the second content at the identified projection region.

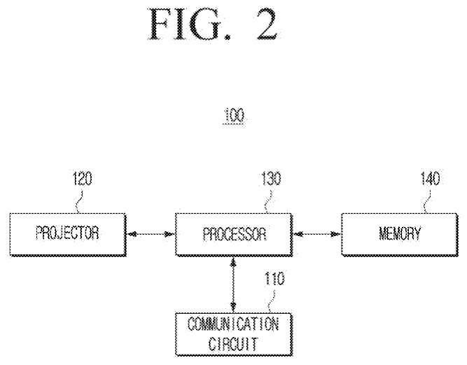

FIG. 2 is a block diagram illustrating a configuration of an electronic apparatus according to an embodiment.

Referring to FIG. 2, an electronic apparatus 100 may include a communication circuit 110, a projector 120, at least one processor 130, and memory 140.

The electronic apparatus 100 may provide images. According to an example, the electronic apparatus may be implemented as a moving-type projector (e.g., a mobile robot) that provides images while moving in a traveling space or as a fixed-type projector disposed at a pre-set position, but is not limited thereto, and the electronic apparatus according to an example may be implemented as electronic apparatuses of different types (e.g., a smartphone, a tablet PC, a TV, etc.) which can provide images.

The communication circuit 110 may input and output data of various types. For example, the communication circuit 110 may transmit and receive data of various types with an external device (e.g., source device), an external storage medium (e.g., a USB memory), or an external server (e.g., WEBHARD) through communication methods such as, for example, and without limitation, an AP based Wi-Fi (e.g., wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

According to an example, the communication circuit 110 may include a Bluetooth low energy (BLE) module. The BLE may refer to Bluetooth technology capable of transmitting and receiving low-power and low-capacity data in a 2.4 GHz frequency bandwidth having a reach radius of approximately 10 m. However, the above is not limited thereto, and the communication circuit 110 may include a Wi-Fi communication module. In other words, the communication circuit 110 may include at least one of the BLE module or the Wi-Fi communication module.

The projector 120 may be a configuration that projects an image to the outside. According to various embodiments of the disclosure, the projector 120 may be implemented with various projection methods (e.g., a cathode-ray tube (CRT) method, a liquid crystal display (LCD) method, a digital light processing (DLP) method, a laser method, etc.). In an example, the CRT method may be basically the same in principle with a CRT monitor. The CRT method may involve displaying an image on a screen by enlarging the image with a lens at a front of a cathode-ray tube (CRT). The method may be classified into a single-tube type and a three-tube type according to a number of CRTs, and in the case of the three-tube type, cathode-ray tubes of red, green, and blue may be separated individually and implemented.

In another example, the LCD method may be a method for displaying an image by transmitting light emitted from a light source to a liquid crystal. The LCD method may be divided into a single-panel type and a three-panel type, and in the case of the three-panel type, light emitted from a light source may be separated into red, green, and blue in a dichroic mirror (a mirror which reflects only light of a specific color and passes the remaining colors) and then the light may be gather back in one place after passing the liquid crystal.

In still another example, the DLP method may be a method for displaying an image using a digital micromirror device (DMD) chip. A projector of the DLP method may include a light source, a color wheel, a DMB chip, a projection lens, and the like. Light output from the light source may show a color as it passes a rotating color wheel. The light that passed the color wheel may be input in the DMD chip. The DMD chip may include many micromirrors, and may reflect light input in the DMD chip. The projection lens may perform a role of enlarging the light reflected from the DMD chip to a size of an image.

In still another example, the laser method may include a diode pumped solid state (DPSS) laser and a galvanometer. The laser that outputs various colors may use a laser that superimposes optical-axes using a special mirror after installing three DPSS lasers for each RGB color. The galvanometer may include a mirror and a motor with high output, and may move the mirror at a fast speed. For example, the galvanometer may rotate the mirror at a maximum of 40 KHz/sec. The galvanometer may be mounted along a scanning direction, and because the projector typically scans a flat surface, the galvanometer may also be disposed divided along the x and y axes.

The projector 120 may include light sources of various types. For example, the projector 120 may include at least one light source from among a lamp, an LED, and a laser. In addition, the projector 120 may output an image in a 4:3 aspect ratio, a 5:4 aspect ratio, or a 16:9 wide aspect ratio according to use of the electronic apparatus 100, a user setting, or the like, and output an image in various resolutions such as, for example, and without limitation, a WVGA (854*480), a SVGA (800*600), a XGA (1024*768), a WXGA (1280*720), a WXGA (1280*800), a SXGA (1280*1024), an UXGA (1600*1200), a Full HD (1920*1080), or the like according to the aspect ratio.

The at least one processor 130 (hereinafter, referred to as ‘processor’) may control the overall operation of the electronic apparatus 100 by being electrically connected with the communication circuit 110, the projector 120, and the memory 140. The processor 130 may be configured as one processor or a plurality of processors. Specifically, the processor 130 may perform, by executing at least one instruction stored in the memory 140, an operation of the electronic apparatus 100 according to various embodiments of the disclosure.

The processor 130 according to an embodiment may be implemented as a digital signal processor (DSP) for processing digital image signals, a microprocessor, a graphics processing unit (GPU), an artificial intelligence (AI) processor, a neural processing unit (NPU), or a time controller (TCON). However, the embodiment is not limited thereto, and may include one or more from among a central processing unit (CPU), a micro controller unit (MCU), a micro processing unit (MPU), a controller, an application processor (AP), a communication processor (CP), or an ARM processor, or may be defined by the relevant terms. In addition, the processor 130 may be implemented as a System on Chip (SoC) or a large scale integration (LSI) in which a processing algorithm is embedded, and may be implemented in a form of an application specific integrated circuit (ASIC) or a field programmable gate array (FPGA).

The memory 140 may store data necessary for the various embodiments. The memory 140 may be implemented in a form of a memory embedded in the electronic apparatus 100 according to data storage use, or implemented in a form of a memory attachable to or detachable from the electronic apparatus 100. For example, data for the driving of the electronic apparatus 100 may be stored in the memory embedded in the electronic apparatus 100, and data for an expansion function of the electronic apparatus 100 may be stored in the memory attachable to or detachable from the electronic apparatus 100.

The memory embedded in the electronic apparatus 100 may be implemented as at least one of a volatile memory (e.g., a dynamic RAM (DRAM), a static RAM (SRAM), or a synchronous dynamic RAM (SDRAM)), or a non-volatile memory (e.g., a one time programmable ROM (OTPROM), programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive or a solid state drive (SSD)). In addition, the memory attachable to or detachable from the electronic apparatus 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory connectable to a USB port (e.g., USB memory), or the like.

According to an embodiment, the processor 130 may obtain the gesture information of the user. According to an example, the gesture information may be data indicating movement of a portion or whole body of the user, and for example, the gesture information may include a hand movement, a facial expression, and the like of the user, but is not limited thereto.

According to an example, the processor 130 may obtain first gesture information of the user through the communication circuit 110. According to an example, the first gesture information of the user may be obtained from a user terminal (e.g., smartphone or tablet PC), but is not limited thereto, and the first gesture information according to an example, may be obtained through a vision sensor.

According to an example, the vision sensor may be a sensor capable of obtaining visual information such as a camera, an infrared sensor, a depth sensor, and the like, and the vision sensor may be a sensor that is capable of tracking user movements by being disposed at a pre-set position in a projection space. However, the above is not limited thereto, and the first gesture information according to an example may be obtained through devices of different types that track the user movements.

Alternatively, according to an embodiment, if the electronic apparatus 100 includes devices of different types that track the user movements, the electronic apparatus 100 may directly obtain the gesture information. For example, the electronic apparatus 100 may include sensors of different types capable of tracking user movements (e.g., camera sensor, infrared sensor, depth sensor, stereo camera, time-of-flight (ToF) sensor, etc.), and the processor 130 may obtain the first gesture information based on sensing data obtained from at least a portion of at least one sensor provided in the electronic apparatus 100.

According to an example, the processor 130 may obtain the first gesture information through a trained neural network model. According to an example, the trained neural network model may be a model trained to identify a gesture of the user when an image (or plurality of image frames) including the user is input. The processor 130 may obtain the first gesture information of the user by inputting an image obtained through a camera sensor provided in the electronic apparatus 100 in the trained neural network model.

Alternatively, according to an example, the electronic apparatus 100 may obtain the first gesture information based on sensing data obtained from a sensor (e.g., acceleration sensor, etc.) included in a wearable device that the user is wearing.

According to an example, the first gesture information may be gesture information obtained from a position within a pre-set distance from an external device that is providing content. For example, if the user is viewing a specific content through a desktop display, the first gesture information may be obtained from a position within a pre-set distance from the desktop.

According to an embodiment, the processor 130 may identify content. According to an example, if the first gesture information of the user is obtained through the communication circuit 110, the processor 130 may identify the second content corresponding to the first gesture information based on the first content provided through a first external device. According to an example, the first external device may be a device of a different type that provides content to the user in the projection space, and the first external device may provide the user with content using at least one of the display or the projector 120, but is not limited thereto. According to an example, the content may be a movie, a game, an image, or an application of a different type, but is not limited thereto.

According to an example, the processor 130 may identify whether the first content is being provided through the first external device. For example, the processor 130 may obtain information about the first content that is currently being provided from the first external device through the communication circuit 110, and identify whether the first content is currently being provided through the first external device based therefrom.

According to an example, the information about the first content may include at least one from among characteristics, format, content, or metadata of the content provided through the first external device, but is not limited thereto, and the information about the first content may include information about various contexts about the first content. For example, if the first content is an application, information about the first content may not only include content provided through the application, but also a position at which the first content is displayed in a display of the first external device. The above will be described below.

According to an example, the processor 130 may identify the second content based on the first content. According to an example, the second content may be content associated with the first content, and may be at least one of a content corresponding to at least a portion of the first content or a content generated based on the first content. For example, the second content may be content that is same as the first content. Alternatively, for example, if the first content is a movie, the second content may be subtitles of the movie or at least a portion of an image of the movie. The second content will be described below.

According to an example, the processor 130 may identify the second content corresponding to the first gesture information. For example, if the first gesture information is a drag input for displaying at least a portion of the first content through a projection surface other than the first external device, the second content may be content enlarged by a pre-set ratio from the first content. Alternatively, if the first gesture information is an input touching at least a portion of a region in the first content, the second content may be content of the region touched in the first content that is enlarged by the pre-set ratio.

According to an embodiment, the processor 130 may identify a projection region in the projection space. According to an example, the processor 130 may identify a first projection region associated with the first external device from among at least one projectable region based on environment information corresponding to the projection space.

According to an example, the projection space may be a space in which the electronic apparatus 100 is disposed. According to an example, the environment information may include at least one of position information of at least one object present in the projection space or information about a projectable region in the projection space, but is not limited thereto. According to an example, the at least one projectable region may be identified based on a sensor of a different type that includes a vision camera.

According to an example, the processor 130 may obtain the environment information from an external device that includes the vision sensor, but is not limited thereto, and the processor 130 may obtain the environment information from an external cloud server or obtain the environment information from at least one electronic apparatus (e.g., internet of things (IoT) device, etc.) present in the projection space. Alternatively, according to an example, if the electronic apparatus 100 includes the vision camera, the electronic apparatus 100 may directly obtain the environment information.

Alternatively, according to an example, the processor 130 may obtain the environment information based on map information corresponding to the projection space. According to an example, the map information may include position information corresponding to each of at least one external device in the projection space. According to an example, the processor 130 may obtain the map information from an external server, but is not limited thereto, and according to an example, the map information may be stored in the memory 140.

According to an example, the processor 130 may identify the first projection region associated with the first external device from among the at least one projectable region. For example, if the first external device is a TV, the projectable region within the pre-set distance from the first external device such as a wall surface or a floor surface in the vicinity of the TV may be selected as the first projection region. According to an example, the processor 130 may identify the first projection region based on at least one from among a position, size, or orientation direction of the first external device. The above will be described below.

According to an embodiment, the processor 130 may display content through the projector 120. According to an example, the processor 130 may display, based on the first projection region associated with the first external device from among the at least one projectable region being identified based on environment information corresponding to the projection space, the second content at the identified first projection region through the projector 120. According to an example, the processor 130 may display the second content adjusted to correspond to a form and size of the first projection region.

According to an example, if the second content is displayed at the first projection region through the projector 120, provision of content that overlaps with the second content from among the first content may be ended. For example, if the second content is same as with the first content, the processor 130 may transmit a control signal for ending the provision of the first content to the first external device through the communication circuit 110. However, the above is not limited thereto.

According to the above-described example, the electronic apparatus 100 may provide, in response to a gesture of the user, an improved multimedia experience to the user by effectively providing content associated with content that being provided or content that is to be provided through the external device to match the surrounding environment.

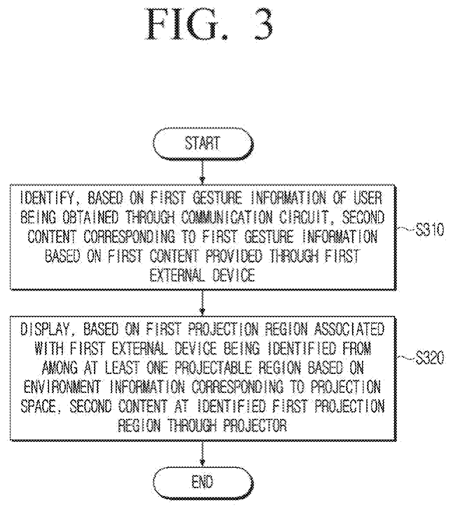

FIG. 3 is a flowchart illustrating an operating method of the electronic apparatus 100 according to an embodiment.

Referring to FIG. 3, according to an embodiment, the operating method may include identifying, based on the first gesture information of the user being obtained through the communication circuit 110, the second content corresponding to the first gesture information based on the first content provided through the first external device (S310).

According to an example, the electronic apparatus 100 may obtain the first gesture information of the user from an external device (e.g., user terminal or vision sensor) through the communication circuit 110. According to an example, the electronic apparatus 100 may identify, based on the first gesture information being obtained, the second content based on the first content provided through the first external device.

According to an embodiment, the operating method may include displaying, based on the first projection region associated with the first external device from among the at least one projectable region being identified based on the environment information corresponding to the projection space, the second content at the identified first projection region through the projector 120 (S320).

According to an embodiment, the electronic apparatus 100 may obtain the environment information corresponding to the projection space. According to an example, the environment information may be obtained from an external device, or obtained through the at least one sensor included in the electronic apparatus 100.

According to an example, the electronic apparatus 100 may identify the first projection region associated with the first external device from among the at least one projectable region based on the environment information. According to an example, the electronic apparatus 100 may display, based on the first projection region being identified, the second content at the first projection region through the projector 120.

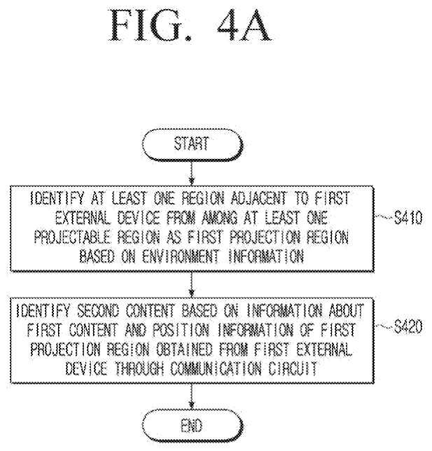

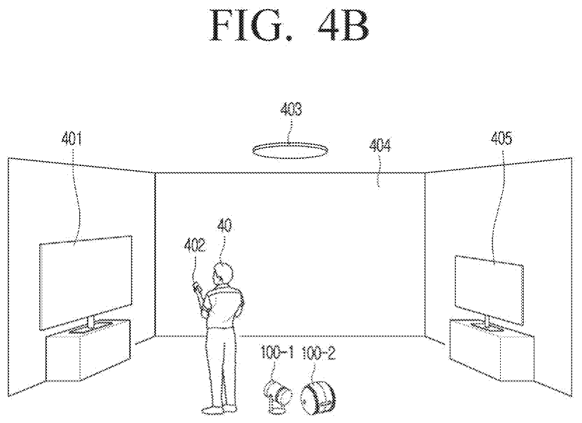

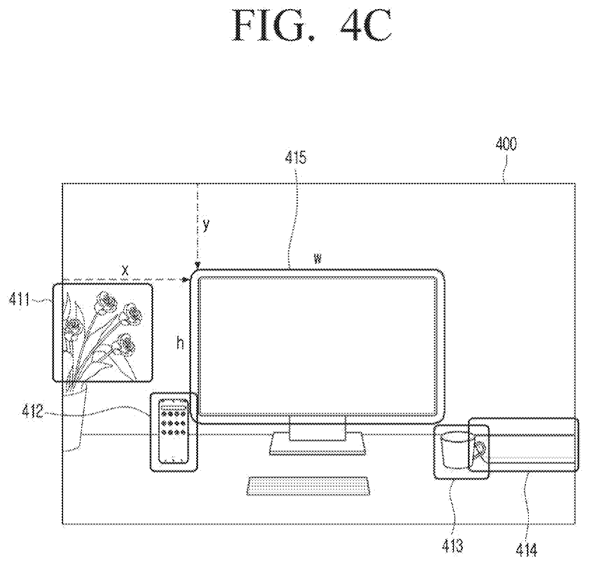

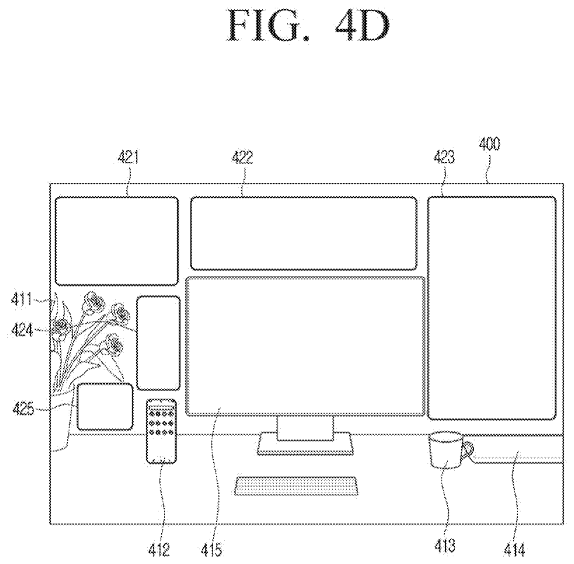

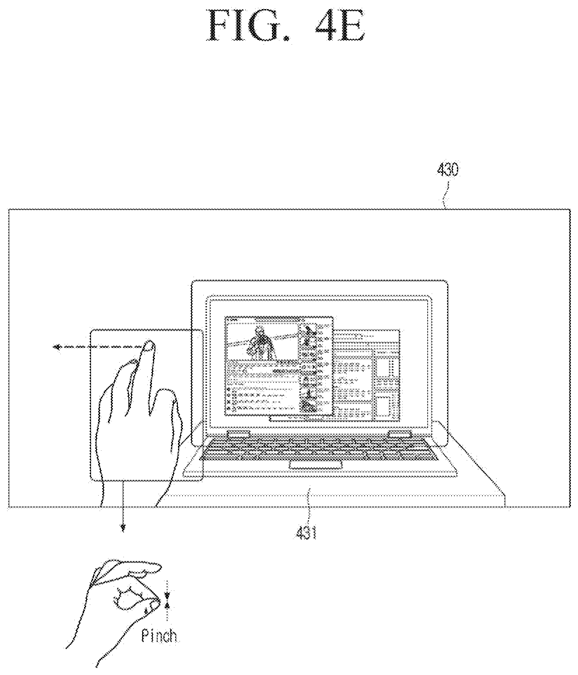

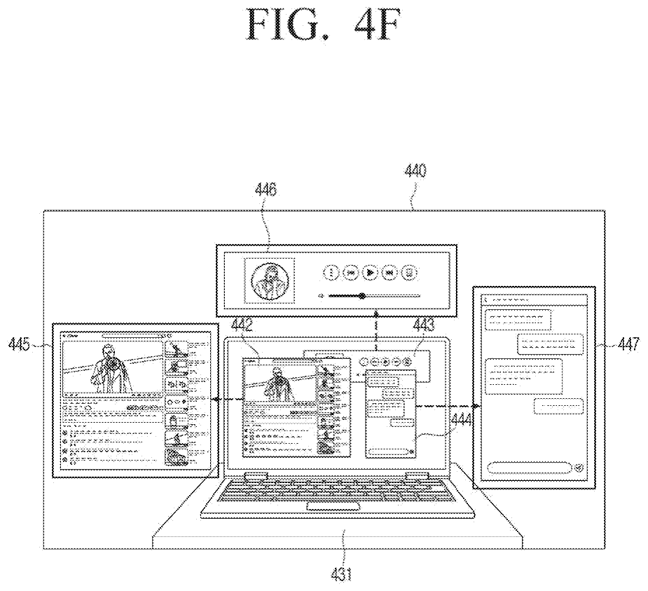

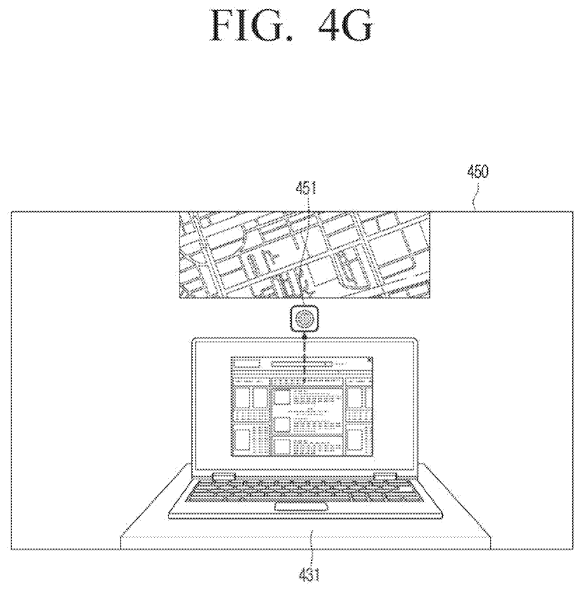

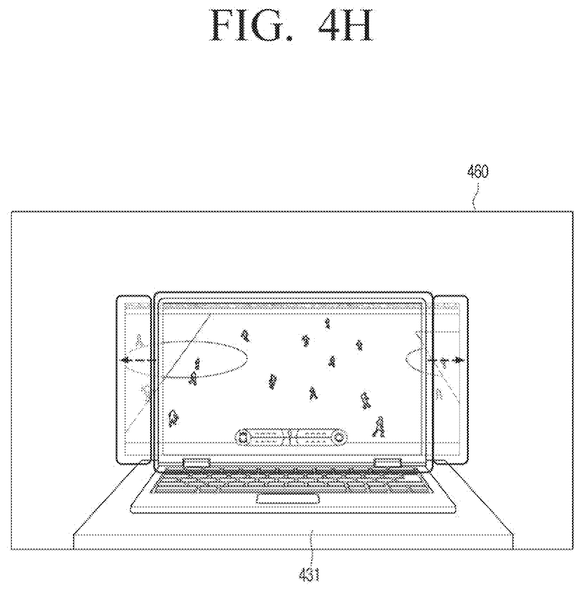

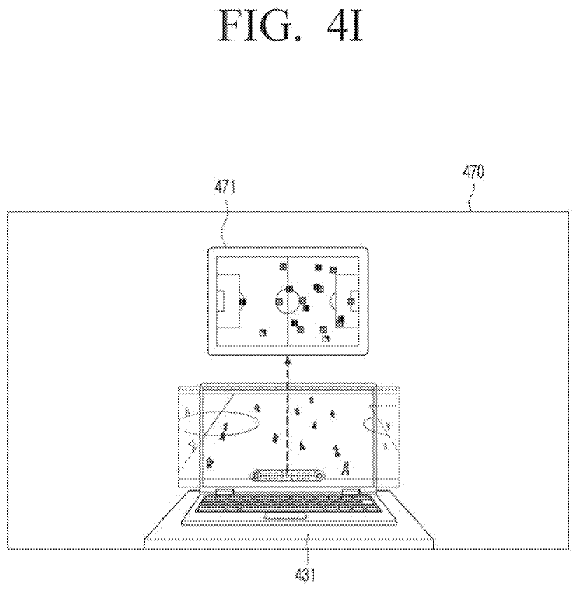

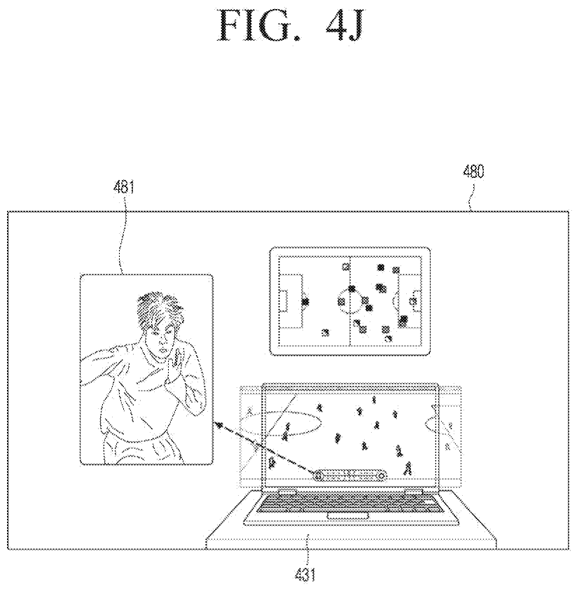

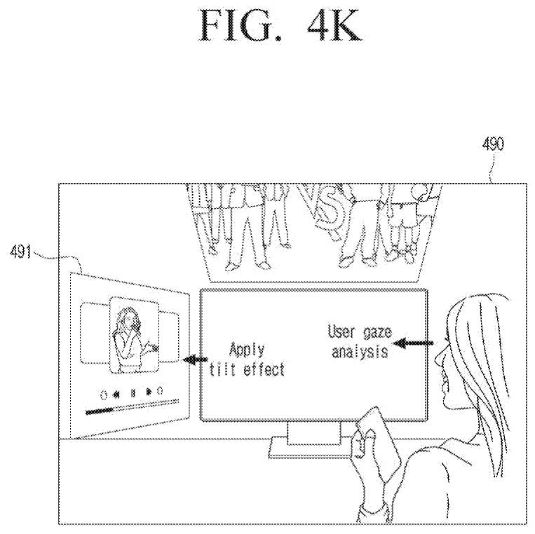

FIG. 4A is a flowchart illustrating a method for identifying the second content according to an embodiment. FIG. 4B to FIG. 4K are diagrams illustrating a method for identifying the second content according to an embodiment.

Referring to FIG. 4A, according to an embodiment, the operating method may include identifying at least one region adjacent to the first external device from among the at least one projectable region as the first projection region based on the environment information (S410).

According to an example, the electronic apparatus 100 may identify at least one region adjacent with the first external device from among the at least one projectable region in the projection space as the first projection region. According to an example, the environment information may include at least one from among position information of each of the at least one external device in the projection space and information about each of the at least one projectable region.

According to an example, referring to FIG. 4B, the at least one external device may be a device present in the projection space. For example, the at least one external device may be devices of different types that include a first display apparatus 401, a user terminal 402, a vision sensor 403, and a second display apparatus 405 that are present in the projection space. According to an example, the electronic apparatus 100 may obtain position information from each of the at least one external devices, but is not limited thereto, and the electronic apparatus 100 may obtain position information from also the vision sensor 403 or an external server.

According to an example, the electronic apparatus 100 may identify the at least one projectable region in the projection space. For example, the projectable region may include a wall surface 404 and may be a different region where refraction of projection light does not occur, but is not limited thereto. According to an example, the electronic apparatus 100 may display an image at the at least one projectable region. For example, if the electronic apparatus 100 is implemented as a traveling robot 100-2 that includes the projector 120, the electronic apparatus 100 may move to the projection region and project an image. Alternatively, if the electronic apparatus 100 is implemented as a fixed-type projector 100-1, the electronic apparatus 100 may project an image by changing a projection direction.

According to an example, referring to FIG. 4C and FIG. 4D, the electronic apparatus 100 may identify a projectable region in a projection space 400. According to an example, the electronic apparatus 100 may identify objects 411, 412, 413, and 414 in the projection space based on information (or, environment information) obtained through the at least one sensor which includes the vision sensor. According to an example, the electronic apparatus 100 may identify at least one projectable region 421, 422, 423, 424, and 425 from among the regions excluding the objects 411, 412, 413, and 414 in the projection space.

According to an example, the electronic apparatus 100 may define a position of an object based on its own coordinate system. According to an example, a distorted projection region may be corrected to a rectangular-shaped flat surface through a pre-set algorithm (e.g., perspective transform algorithm).

According to an example, the electronic apparatus 100 may identify a projectable region based on a position of an identified object (e.g., object 411, 412, 413, or 414). For example, the projectable region may include at least one from among a relatively left projectable region 421, 424, or 425, an upper projectable region 422, and a right projectable region 423 based on the position of the display 415, and each of the regions may be identified as a minimum rectangular-shaped sized based on resolutions corresponding to the projector 120. For example, the rectangles described may be set based on a minimum size by which visibility of texts is secured.

According to an example, referring back to FIG. 4A, the electronic apparatus 100 may identify the at least one projectable region adjacent with the first external device as the first projection region based on the environment information. For example, if the first display apparatus 401 is identified as the first external device, the first projection region may be a region adjacent with the first display apparatus 401. In this case, the first projection region may include a plurality of projectable regions as shown in FIG. 4D.

According to an embodiment, the operating method may include identifying, the second content based on information about the first content and position information of the first projection region obtained from the first external device through the communication circuit 110 (S420).

According to an example, information about the first content may include at least one from among the characteristics, format, content, or metadata of the content being provided through the first external device, but is not limited thereto, and the information about the first content may include information about various contexts about the first content. According to an example, if the first content is an application, the information about the first content may include information about a position at which the first content is displayed in the display of the first external device. According to an example, the electronic apparatus 100 may obtain information about the first content from the first external device.

According to an example, the first projection region may include a plurality of sub projection regions. According to an example, the electronic apparatus 100 may identify position information of the first projection region that includes the position information of each of the plurality of sub projection regions. According to an example, the position information of the first projection region may be information about relative positions of each of the sub projection regions based on the first external device. For example, the electronic apparatus 100 may identify each of the sub projection region positioned at a left side, an upper end, or a right side from the first external device.

According to an example, the electronic apparatus 100 may identify the second content based on information about the first content and position information of the first projection region.

For example, referring to FIG. 4F, the electronic apparatus 100 may obtain information about the first content from a notebook which is the first external device. The first content may include a plurality of contents including a first sub content 442, a second sub content 443, and a third sub content 444. According to an example, the first content may be content being displayed in the display of the first external device (e.g., notebook 431). The electronic apparatus 100 may display, based on gesture information (e.g., a gesture for enlarging and displaying the first content at the projection region) being identified, the first sub content 442 displayed at a relatively left side in the display of the first external device at a left side sub projection region 445 positioned at a relatively left side from the first external device based on the information about the first content. Alternatively, the electronic apparatus 100 may display the second sub content 443 displayed at a relatively upper end in the display at an upper end sub projection region 446 positioned at a relatively upper end from the first external device. Alternatively, the electronic apparatus 100 may display the third sub content 444 displayed at a relatively right side in the display at a right side sub projection region 447 positioned at a relatively right side from the first external device. According to an example, the plurality of sub projection regions 445, 446, and 447 may be projectable regions adjacent with the first external device within a projection space 440.

Alternatively, according to an example, the electronic apparatus 100 may adjust and display each of the first sub content 442, the second sub content 443, and the third sub content 444 by a pre-set ratio based on sizes of the corresponding sub projection regions. Alternatively, for example, the electronic apparatus 100 may also display only the content of at least a portion of each of the sub contents at each corresponding sub projection regions.

According to an example, the electronic apparatus 100 may identify, based on information about the first content and information about the projectable region, at least one sub content (e.g., first sub content 442, second sub content 443, and third sub content 444) to display through the projector 120. For example, because the projection region may not be secured to an extent that all applications that are being provided through the first external device can be enlarged to the space, the electronic apparatus 100 may first identify visual content (e.g., movie, etc.) displayable in the projectable region, and display the above at the sub projection region. In this case, in the first external device, an application corresponding to the sub content to be displayed through the projector 120 may be ended.

Referring back to FIG. 4A, the second content according to an example may be at least one of content corresponding to at least a portion of the first content or content generated based on the first content. According to an example, referring to FIG. 4H, the second content may be content corresponding to a portion of the first content. For example, the electronic apparatus 100 may identify an optimal aspect ratio based on types of the first content, and identify the second content to be displayed at the first projection region in a projection space 460 based on the identified aspect ratio. According to an example, information about the optimal aspect ratio may be obtained from an external server, but is not limited thereto, and the information about the aspect ratio may be stored in the memory. According to the above-described example, the user may be provided with content in which the first content is enlarged through a plurality of devices.

According to an example, referring to FIG. 4I, a second content (e.g., content 471) may be content corresponding to a portion of the first content. For example, if the first content is a soccer game content, the electronic apparatus 100 may identify, based on information about the first content, content 471 which enlarged a sub content being displayed relatively small in the soccer game content to a pre-set ratio as the second content, and display the above at the first projection region in a projection space 470.

According to an example, the electronic apparatus 100 may obtain information about the content displayed in the first external device in real-time. Alternatively, according to an example, the electronic apparatus 100 may identify a region of interest corresponding to a specific object from among the content being displayed in the first external device using a pre-set object recognition algorithm, and identify content corresponding to the identified region of interest as the content 471. Alternatively, the electronic apparatus 100 according to an example may use application information corresponding to the first content, and identify the content 471 by cropping only a pre-set region.

According to an example, referring to FIG. 4J, a second content (e.g., content 481) may be content generated based on the content of the first content. For example, if the first content is a soccer game content, the electronic apparatus 100 may generate, based on information about the first content, the content 481 which includes information about players provided in the second game content, and display the above at the first projection region in a projection space 480. According to an example, the electronic apparatus 100 may obtain information about the content 481 from an external cloud server, but is not limited thereto.

According to an example, the electronic apparatus 100 may obtain information about content being displayed in the first external device in real-time. Alternatively, the electronic apparatus 100 according to an example may identify a region of interest corresponding to a specific object from among content being displayed in the first external device using the pre-set object recognition algorithm, and identify the content corresponding to the identified region of interest as the content 481. Alternatively, in the case of the specific content type (e.g., soccer game), because UIs of different types including map information are present at pre-set positions, the electronic apparatus 100 may identify the region of interest using the same.

According to an example, the electronic apparatus 100 may perform web browsing for content corresponding to the region of interest, and identify an image obtained as a result of the performance as the content 481.

According to an example, referring to FIG. 4K, a second content (e.g., content 491) may be generated based on a viewing angle of the user. According to an example, the electronic apparatus 00 may obtain posture information including the viewing angle of the user through the vision sensor, the user terminal, or the at least one sensor included in the electronic apparatus 100. The electronic apparatus 100 may identify content which is the first content tilted at a pre-set angle based on the obtained posture information as the content 491, and display the above at the first projection region in a projection space 490.

According to an example, referring to FIG. 4E, the first gesture information may be information about a gesture obtained from a position within a pre-set distance from the first external device. For example, the electronic apparatus 100 may display, based on a gesture (e.g., pinch gesture) of the user for displaying the second content at a projection region being identified within a pre-set distance from the first external device (e.g., notebook 431) in a projection space 430, the second content at the first projection region.

According to an example, the electronic apparatus 100 may identify skeleton information of a hand of the user through sensing data obtained through the at least one sensor. For example, the electronic apparatus 100 may identify the skeleton information of the user from an external device (e.g., vision sensor, etc.). According to an example, the electronic apparatus 100 may identify whether a hand of the user is positioned within a pre-set distance from the first external device using at least one from among skeleton information and position information in the projection space of the user. According to an example, the electronic apparatus 100 may identify whether a hand of the user is positioned within the pre-set distance from the first external device based on a position of the middle finger (third finger) of the user from among the skeleton information. According to an example, the electronic apparatus 100 may identify, based on the skeleton information, whether a hand of the user moves away from the display while a specific gesture of the user is maintained, and identify the first gesture information.

According to an example, referring to FIG. 4G, the electronic apparatus 100 may perform rendering of a cursor 451 in real-time, and display through the projector 120. The electronic apparatus 100 according to an example may receive information about at least one from among an amount of movement in a position of the cursor 451, a position of the cursor 451 in the display, and an event (click, drag) of the cursor 451 from the first external device.

According to an example, if the cursor 451 cannot be rendered to the same size as the cursor 451 visible in the display according to the resolution of the projector 120, the electronic apparatus 100 may display a separate interface of the cursor 451.

According to an example, if the cursor 451 moves outside the perimeter of the display, the electronic apparatus 100 may use a separate system of the cursor 451 and define the position of the cursor 451 in the enlarged space based on the position of the display of the first external device, and the position of the cursor 451 in the display.

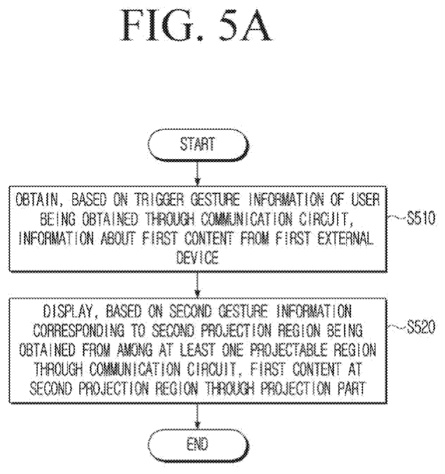

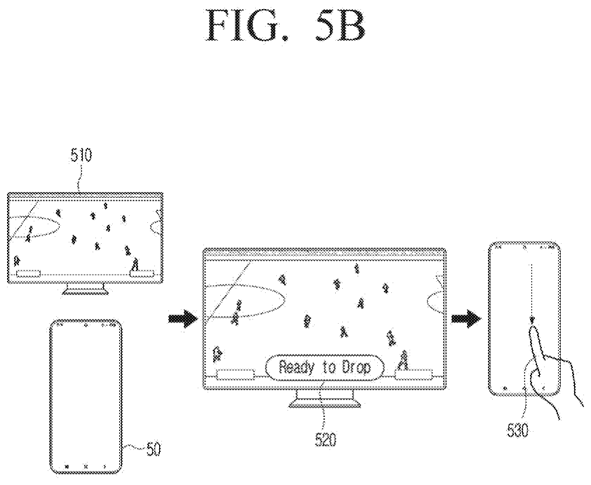

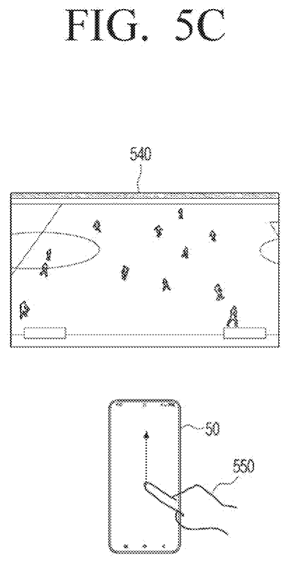

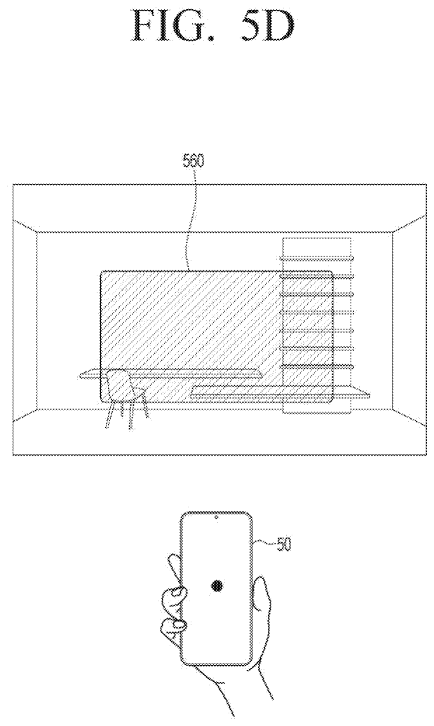

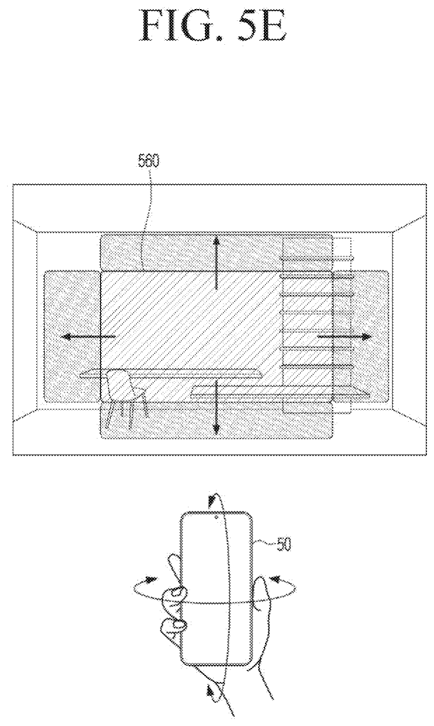

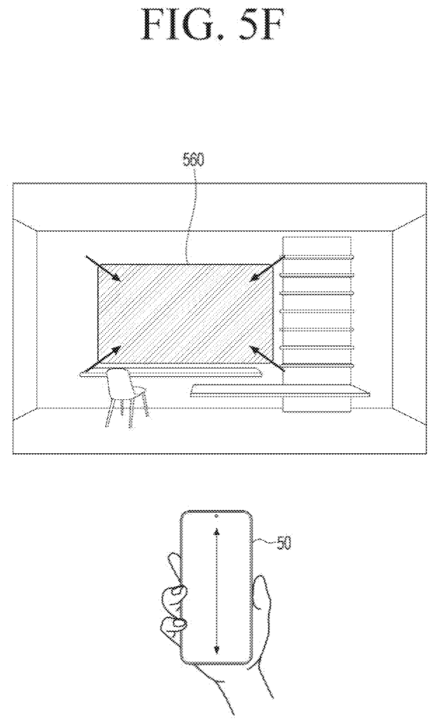

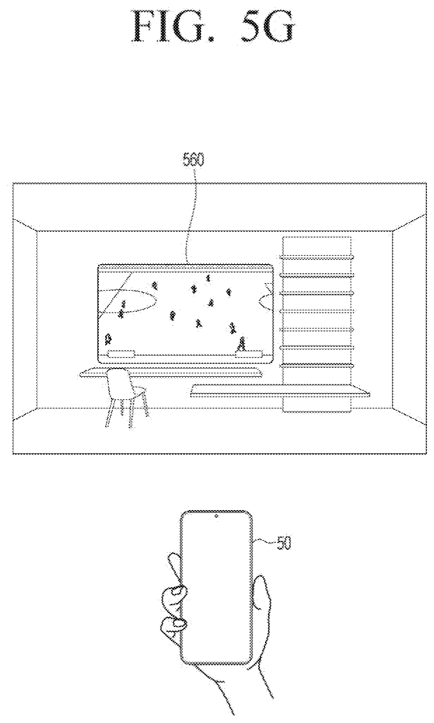

FIG. 5A is a flowchart illustrating a method for displaying content based on gesture information of the user according to an embodiment. FIG. 5B to FIG. 5G are diagrams illustrating a method for displaying content based on the gesture information of the user according to an embodiment.

Referring to FIG. 5A, according to an embodiment, the operating method may include obtaining, based on trigger gesture information of the user being obtained through the communication circuit 110, information about the first content from the first external device (S510).

According to an example, the trigger gesture information of the user may be a specific motion or signal of the user for starting an interaction. For example, a trigger gesture of the user may be a trigger gesture for providing first content which is currently being provided in the first external device in another external device.

According to an example, the trigger gesture of the user may be obtained based on a hand movement of the user or a movement of the user terminal. For example, the electronic apparatus 100 may obtain information associated with movement of a hand of the user, and identify the trigger gesture information of the user based therefrom. Alternatively, for example, the electronic apparatus 100 may obtain information associated with a movement of the user terminal through at least one sensor (e.g., gyro sensor) included in the user terminal, and identify the trigger gesture information of the user based therefrom. However, for convenience of description below, the above will be described by limiting the example to the gesture information of the user being obtained through the user terminal.

According to an example, referring to FIG. 5B, the electronic apparatus 100 may obtain the trigger gesture of the user through a user terminal 50. According to an example, the electronic apparatus 100 may provide, based on the trigger gesture of the user being obtained, notification information 520 (or a control signal for providing notification information) to a first external device 510. According to an example, the notification information 520 may be information notifying that the content currently being provided from the first external device can be provided in another external device. For example, the notification information may be information including a text ‘Ready to Drop’, but is not limited thereto. According to an example, the electronic apparatus 100 may obtain additional gesture information of the user after providing the notification information. According to an example, the additional gesture information may be information about a gesture 530 (e.g., drag down input) for temporarily storing the first content being provided in the first external device. According to an example, the electronic apparatus 100 may obtain, based on additional gesture information being obtained, information about the first content from the first external device.

According to an embodiment, referring back to FIG. 5A, the operating method may include displaying, based on second gesture information corresponding to a second projection region from among the at least one projectable region being obtained through the communication circuit 110, the first content at the second projection region through the projector 120 (S520).

According to an example, the electronic apparatus 100 may identify, after the trigger gesture information of the user is obtained, whether the second gesture information is obtained. According to an example, the second gesture information may be information about a gesture of the user for displaying content at the second projection region from among the at least one projectable region. For example, the second gesture information may be information about a gesture corresponding to a drag up input to the second projection region, but is not limited thereto. According to an example, the second projection region may be at least one region from among the at least one projectable region in the projection space.

According to an example, the electronic apparatus 100 may display, based on the second gesture information being obtained, the first content at the second projection region. Alternatively, according to an example, the electronic apparatus 100 may also display the second content identified based on information about the first content at the second projection region.

According to an example, referring to FIG. 5C, the electronic apparatus 100 may provide content 540 at the second projection region based on second gesture information 550. For example, the electronic apparatus 100 may obtain a gesture corresponding to the drag up input to the second projection region from the user terminal. The electronic apparatus 100 may identify the second projection region corresponding to the obtained gesture, and provide the first content at the identified second projection region. Alternatively, the electronic apparatus 100 may also provide the second content based on a size or position of the identified second projection region.

Referring back to FIG. 5A, according to an example, the electronic apparatus 100 may obtain a user input for providing content that is being provided in the first external device to another external device. For example, the electronic apparatus 100 may transmit, based on a user input for selecting a second external device from among the at least one external device in the projection space being obtained from the user terminal, information about the first content to the second external device. The second external device may provide the first content based on the received information about the first content.

Alternatively, according to an example, the electronic apparatus 100 may also display the first content based on a user input for selecting any one projection region from among the at least one projectable region. For example, the electronic apparatus 100 may display the first content at the second projection region when a user input for selecting the second projection region is received.

According to an example, referring to FIG. 5D to FIG. 5G, the electronic apparatus 100 may adjust a size of the second projection region. According to an example, referring to FIG. 5D, the electronic apparatus 100 may activate, based on a long press input being received from the user terminal, a position adjustment mode corresponding to the second projection region. According to an example, referring to FIG. 5E, if a gesture input toward a specific direction is obtained through the user terminal while a home button of the user terminal is in a pressed state, the electronic apparatus 100 may adjust a position of the second projection region based on the gesture input toward a specific direction. According to an example, referring to FIG. 5F, if a touch input or a swipe input of the user with respect to the user terminal is obtained, the electronic apparatus 100 may enlarge or minimize the size of the second projection region based on the obtained input. According to an example, referring to FIG. 5G, the electronic apparatus 100 may project the first content at the second projection region completed with position and size adjustments.

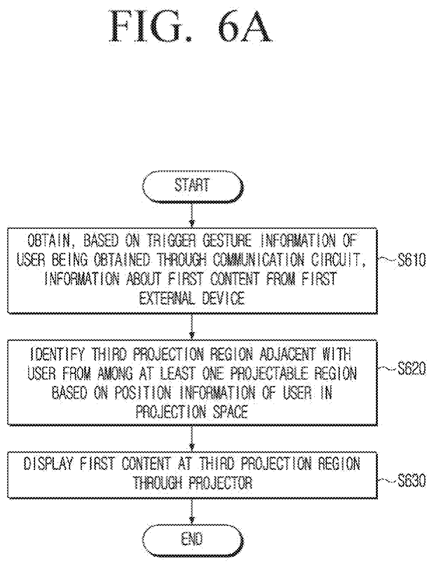

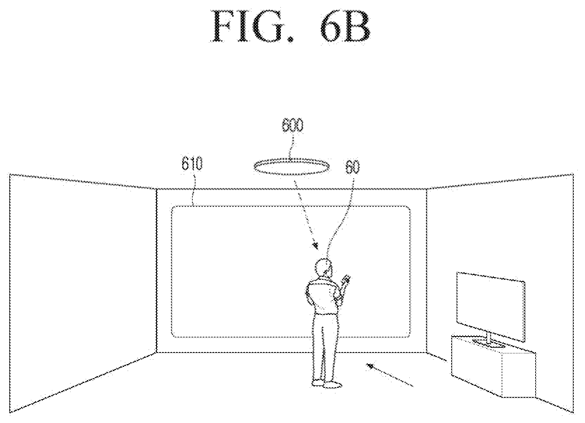

FIG. 6A is a flowchart illustrating a method for displaying the first content at a third projection region according to an embodiment. FIG. 6B is a diagram illustrating a method for displaying the first content at the third projection region according to an embodiment.

Referring to FIG. 6A and FIG. 6B, according to an embodiment, the operating method may include obtaining, based on trigger gesture information of a user 60 being obtained through the communication circuit 110, information about the first content from the first external device (S610).

According to an example, the electronic apparatus 100 may obtain the trigger gesture information of the user 60 through the communication circuit 110. According to an example, the electronic apparatus 100 may obtain, based on the trigger gesture information being obtained, information about the first content from the first external device.

According to an embodiment, the operating method may include identifying a third projection region 610 adjacent to the user 60 from among the at least one projectable region based on position information of the user 60 in the projection space (S620).

According to an example, the electronic apparatus 100 may identify the position information of the user 60 in the projection space. According to an example, the electronic apparatus 100 may obtain the position information of the user 60 in the projection space through the at least one sensor 600 (e.g., vision sensor) in the projection space. Alternatively, the electronic apparatus 100 may identify position information of a terminal of the user 60 as the position information of the user 60 in the projection space.

According to an example, the electronic apparatus 100 may identify a projectable region adjacent with the user 60 from among the at least one projection region as the third projection region 610. In this case, the electronic apparatus 100 may identify, based on position information of the user 60, a projection region corresponding to a gaze direction of the user 60 as the third projection region 610.

According to an embodiment, the operating method may include displaying the first content at the third projection region 610 through the projector 120 (S630).

According to an example, the electronic apparatus 100 may display content (e.g., sample content) at the third projection region 610 even if gesture information (e.g., second gesture information) of the user 60 for displaying the first content is not received. For example, the electronic apparatus 100 may display affordance for an image of a motion graphic type at the identified third projection region 610.

According to an example, the electronic apparatus 100 may display, based on second gesture information of the user 60 being obtained, the first content at the third projection region 610.

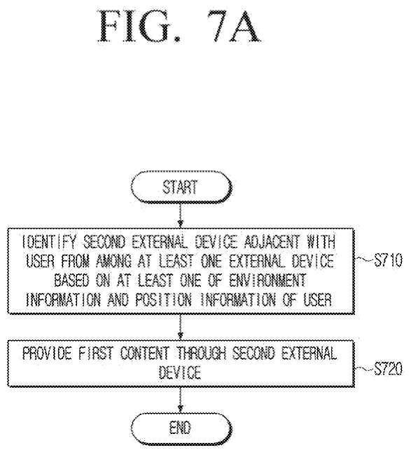

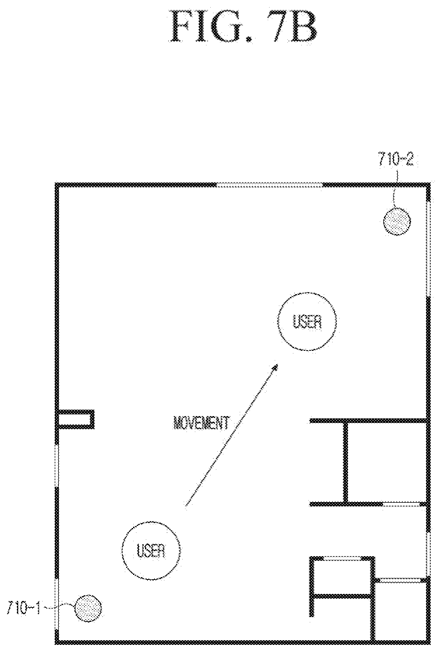

FIG. 7A is a flowchart illustrating a method for providing the first content according to an embodiment. FIG. 7B is a diagram illustrating a method for providing the first content through the second external device according to an embodiment.

Referring to FIG. 7A and FIG. 7B, according to an embodiment, the operating method may include identifying a second external device 710-2 adjacent with the user from among the at least one external device based on at least one from among the environment information and the position information of the user (S710).

According to an example, the electronic apparatus 100 may identify, based on position information corresponding to the at least one external device in the projection space, the second external device 710-2 adjacent with the user from among the at least one external device.

For an example, it may be assumed that the first content is being provided through a first external device 710-1. If the user at an adjacent position from the first external device 710-1 moves in the projection space, the electronic apparatus 100 may identify an adjacent device from the position from which the user moved as the second external device 710-2.

According to an embodiment, the operating method may include providing the first content through the second external device 710-2 (S720).

According to an example, the electronic apparatus 100 may provide information about the first content being provided through the first external device 710-1 to the identified second external device 710-2. The second external device 710-2 according to an example may provide the first content based on the obtained information about the first content. Alternatively, if the second external device 710-2 does not include a display, the second external device 710-2 may provide information about the first content (e.g., audio corresponding to the first content). According to an example, the electronic apparatus may transmit, based on information about the first content being provided to the second external device 710-2, a control signal for ending the provision of the first content from the first external device 710-1 to the first external device 710-1 through the communication circuit 110.

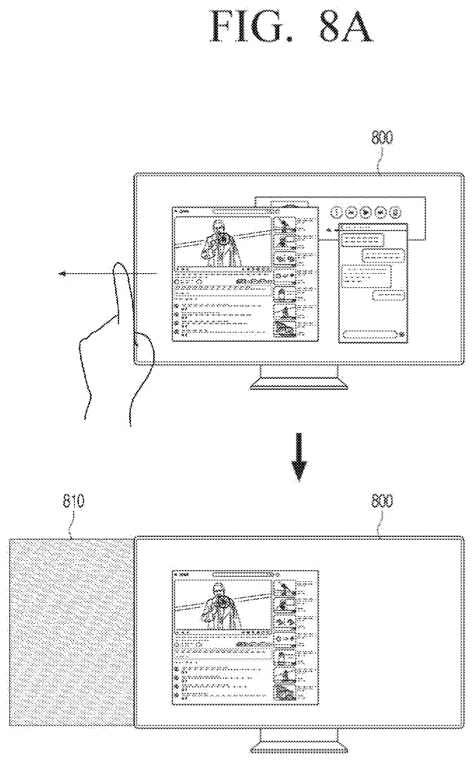

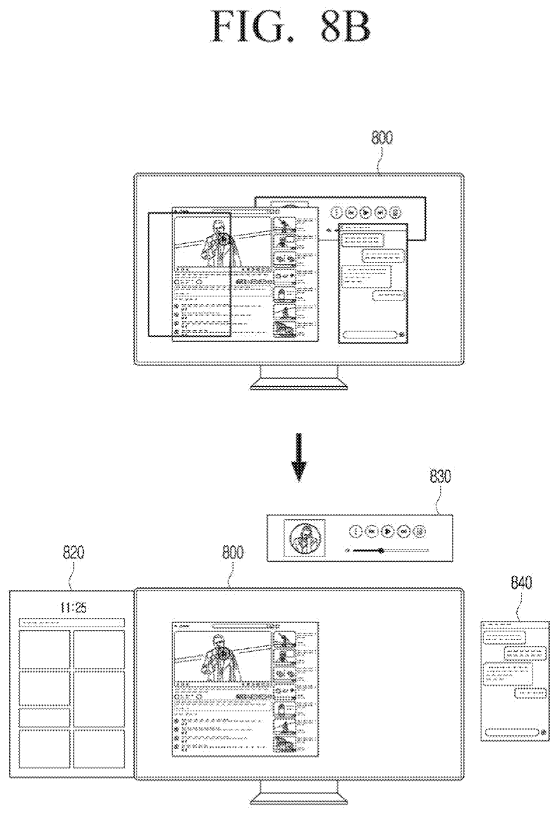

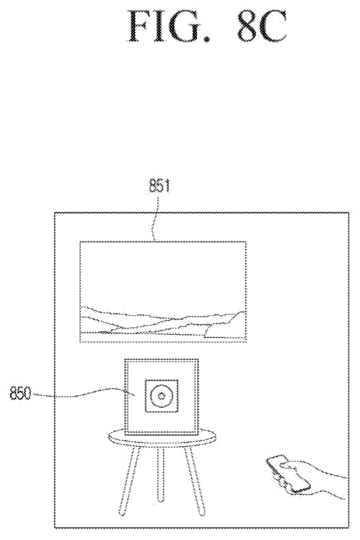

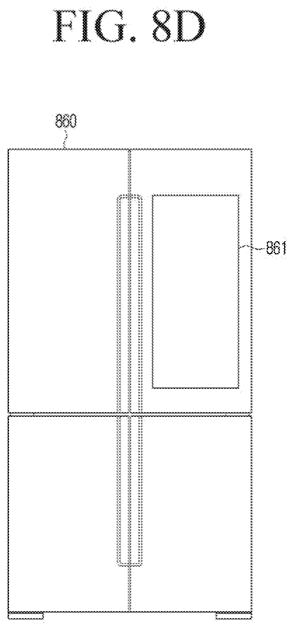

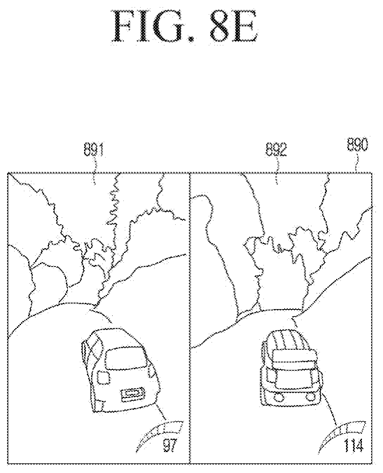

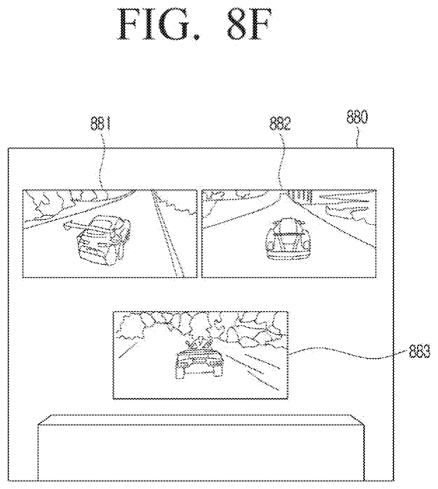

FIG. 8A to FIG. 8F are diagrams illustrating a method for providing the second content according to an embodiment.

Referring to FIG. 8A, the electronic apparatus 100 according to an embodiment may display, based on the drag input of the user being obtained from an adjacent position from the first external device (e.g., monitor 800), content corresponding to the drag input from among the first content provided from the first external device at a projection region 810. According to an example, if the drag input of the user is received from a left region based on the first external device, the electronic apparatus 100 may display content corresponding to a relatively left region from among the content displayed in the first external device at the projection region 810.

Referring to FIG. 8B, according to an embodiment, the electronic apparatus 100 may display each of a plurality of contents provided from the first external device (e.g., monitor 800) at projection regions. According to an example, the electronic apparatus 100 may obtain, from the first external device, information about the first content. The first content may include a first sub content, a second sub content, and a third sub content. According to an example, the electronic apparatus 100 may display, based on gesture information being identified (e.g., a gesture for enlarging and displaying the first content at a projection region), the first sub content displayed at a relatively left side in the display of the first external device at a first sub projection region 820 positioned at a relatively left side from the first external device. Alternatively, the electronic apparatus 100 may display the second sub content displayed at a relatively upper end in the display at a second sub projection region 830 positioned at a relatively upper end from the first external device. Alternatively, the electronic apparatus 100 may display the third sub content displayed at a relatively right side in the display at a third sub projection region 840 positioned at a relatively right side from the first external device. According to an example, the electronic apparatus 100 may display each of the first sub content, the second sub content, and the third sub content simultaneously.

Referring to FIG. 8C, the electronic apparatus 100 according to an embodiment may display information associated with content being provided from a non-screen device at a projection region 851. According to an example, it may be assumed that an external device 850 is a device of a frame type that includes a speaker. The electronic apparatus 100 may identify, based on information about music content provided from the external device 850 being obtained, image content associated with the music content based therefrom. The electronic apparatus 100 may display the identified image content at the projection region 851 adjacent with the external device 850.

Referring to FIG. 8D, the electronic apparatus 100 according to an embodiment may display information associated with content provided from a home appliance product at a projection region 861. According to an example, it may be assumed that an external device 860 is a refrigerator. The electronic apparatus 100 may identify, based on information about content (e.g., information about a function of the refrigerator, a food recipe, etc.) provided from the refrigerator being obtained, information of an image type based therefrom. For example, the information of an image type may be information associated with a function of the refrigerator or a recipe image, but is not limited thereto. The electronic apparatus 100 may display the identified information of the image type at the projection region 861 in the refrigerator.

Referring to FIG. 8E and FIG. 8F, the electronic apparatus 100 according to an embodiment may process the first content provided from the first external device and display at a projection region.

According to an example, the electronic apparatus 100 may divide, based on a type of content provided from the first external device, the content into a plurality of sub contents. For example, the type of content may be a different type that includes a multi-player game content type provided from viewpoints of each of a plurality of players. The electronic apparatus 100 may divide, based on the first content being a multi-player game content type, the first content into sub contents corresponding to each of the plurality of players. For example, the electronic apparatus 100 may divide the first content into a plurality of sub contents corresponding to each of the plurality of players based on image information about the first content being provided.

According to an example, the electronic apparatus 100 may display the plurality of divided sub contents at each of the projection regions. For example, as shown in FIG. 8E, it may be assumed that there are two players. The electronic apparatus 100 may provide each of the divided sub contents at a pre-set aspect ratio (e.g., width:length=0.6:1). However, the embodiment is not limited thereto, and each of the sub contents may be provided at different aspect ratios. According to an example, the electronic apparatus 100 may identify an aspect ratio corresponding to content based on information about content provided from the first external device, and provide the content at the identified aspect ratio.

Alternatively, for example, as shown in FIG. 8F, it may be assumed that there are three players. The electronic apparatus 100 may divide the first content into three sub contents corresponding to each of the plurality of players. The electronic apparatus 100 may provide each of the divided sub contents at a pre-set aspect ratio (e.g., width:length=16:9). However, the above is not limited thereto.

According to an example, the electronic apparatus 100 may divide and display each of the sub contents in the projection region. For example, as shown in FIG. 8F, the electronic apparatus 100 may divide each of the sub contents 881, 882, and 883 in the projection region 880 and display respectively. However, the above is not limited thereto, and for example, as shown in FIG. 8E, the electronic apparatus 100 may display each of the sub contents 891 and 892 at a position adjacent to each other in the projection region 890.

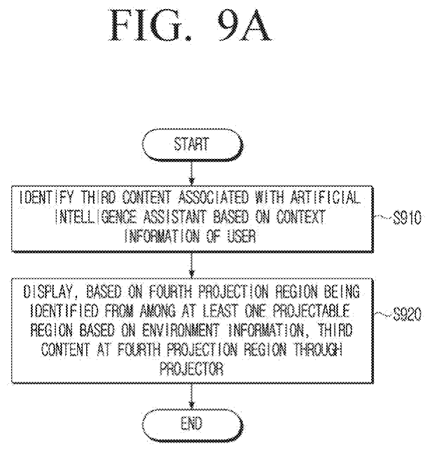

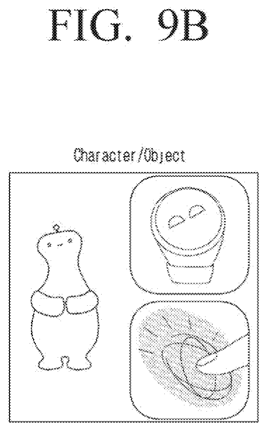

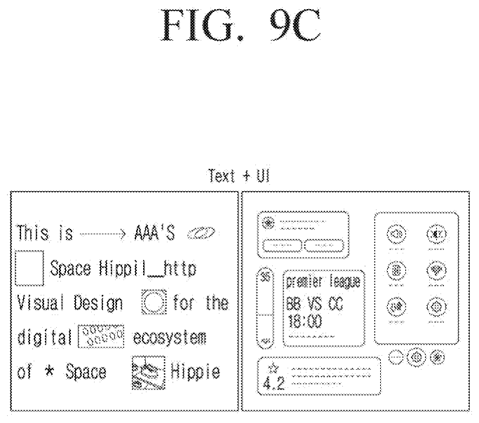

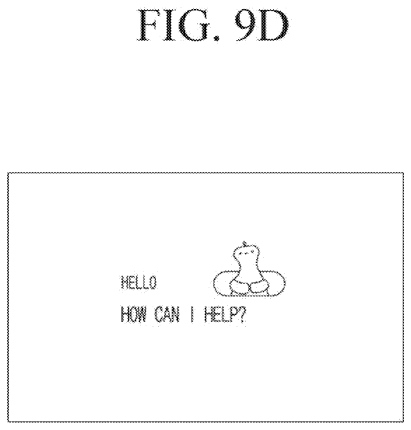

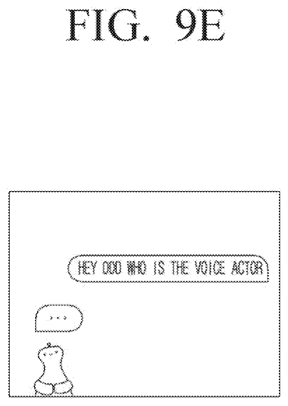

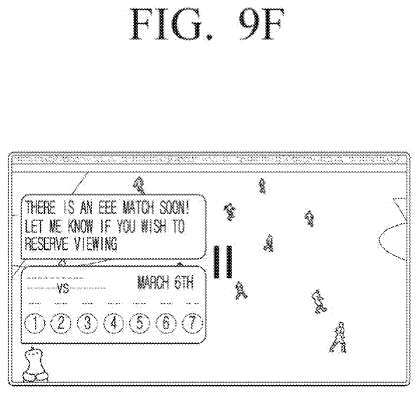

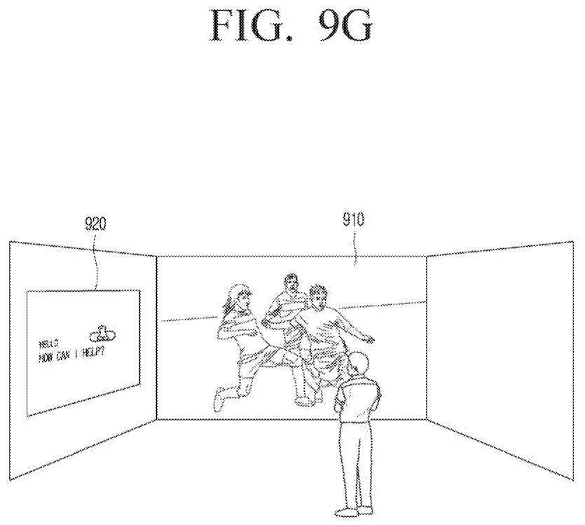

FIG. 9A is a flowchart illustrating a method for displaying a third content according to an embodiment. FIG. 9B to FIG. 9F are diagrams illustrating a method for displaying the third content according to an embodiment.

Referring to FIG. 9A, FIG. 9B, and FIG. 9C, according to an embodiment, the operating method may include identifying the third content associated with an artificial intelligence assistant based on context information of the user (S910). According to an example, the artificial intelligence assistant may be an application for providing information corresponding to voice or text commands of the user using at least one of a natural language processing or a machine learning algorithm. According to an example, the third content may be content obtained through the artificial intelligence assistant (or, at least one application associated therewith).

Alternatively, the third content according to an example may be identified based on information obtained from the at least one external device in the projection space. For example, if a water container in an air dresser in the projection space is full, the air dresser may transmit relevant information to the electronic apparatus 100 through the communication circuit 110. The electronic apparatus 100 may identify notification information corresponding to ‘empty air dresser water container’ as the third content based on the received information.

According to an example, context information of the user may include information about whether content (e.g., the first content) is viewed by the user, a position of the user, or the user's purpose for the artificial intelligence assistant. According to an example, information about purpose may be information about whether the user's purpose for the artificial intelligence assistant is to obtain information or converse. According to an example, the electronic apparatus 100 may identify context information based on movement information of the user obtained through the at least one sensor (e.g., vision sensor) or information obtained through an external device (e.g., information on whether content is being provided).

According to an example, the electronic apparatus 100 may identify the third content based on context information (S910). For example, the electronic apparatus 100 may identify, based on the context information indicating that the user's purpose for the artificial intelligence assistant is to converse, content including an object of a character type as the third content as shown in FIG. 9B. Alternatively, for example, the electronic apparatus 100 may identify, based on the context information indicating that the user has not viewed the current content, content of a text type as the third content as shown in FIG. 9C. Alternatively, the electronic apparatus 100 may identify, based on the context information indicating that the user's purpose for the artificial intelligence assistant is obtaining information, content of a user interface (UI) type as the third content. Alternatively, the electronic apparatus 100 may provide, based on the context information indicating that the user is viewing the content, at least one from among content of a blur, gradient, or a lighting type as the third content. The electronic apparatus 100 may identify, based on the user viewing the content, voice information corresponding to the artificial intelligence assistant together with content of the above-described type as the third content.

According to an example, referring to FIG. 9D, the electronic apparatus 100 may identify, based on receiving a wake up input corresponding to the artificial intelligence assistant from the user, third content including guide information. Alternatively, according to example, referring to FIG. 9E, the electronic apparatus 100 may identify, based on a user input for calling the artificial intelligence assistant being received while a content is being displayed in the projection region, content including a character corresponding to the artificial intelligence assistant as the third content. Alternatively, according to an example, referring to FIG. 9F, the electronic apparatus 100 may identify, based on the content displayed in the projection region being identified as in a paused state, content including information associated with content displayed in the current projection region as the third content.

According to an embodiment, referring back to FIG. 9A, the operating method may include displaying, based on a fourth projection region from among the at least one projectable region being identified based on environment information, the third content at the fourth projection region through the projector 120 (S920).

According to an example, referring to FIG. 9G, the third content may be displayed in a pre-set projectable region 920 in a projection space, According to an example, the third content associated with the artificial intelligence assistant may be displayed in an adjacent separate region from a projection region 910 in which a main content (e.g., the first content) is displayed. According to an example, each of the main content and the third content may be displayed through separate projection devices, but is not limited thereto, and the main content and the third content according to an example may also be displayed through the electronic apparatus 100. If each of the content is displayed through a plurality of projection devices that include the electronic apparatus 100, the electronic apparatus 100 may transmit information about content to an external projection device, and the external projection device may display the content based therefrom.

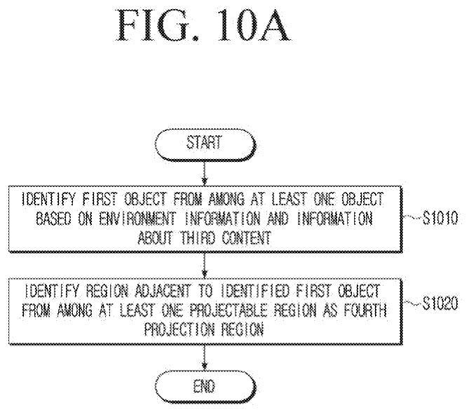

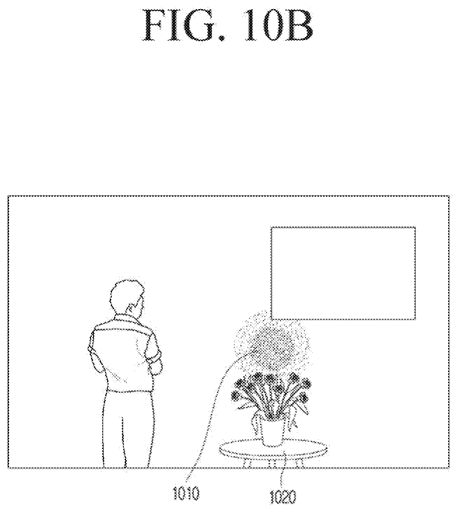

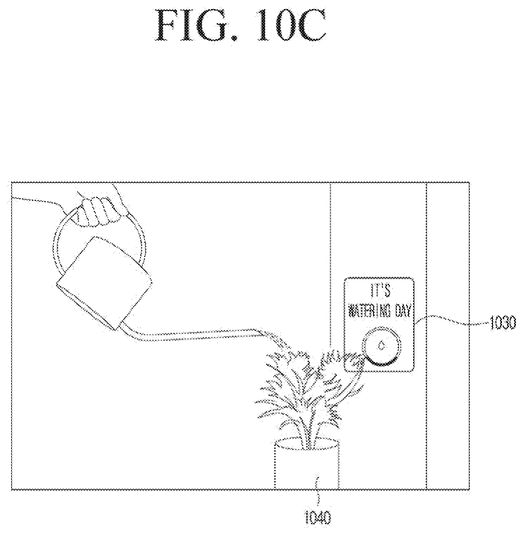

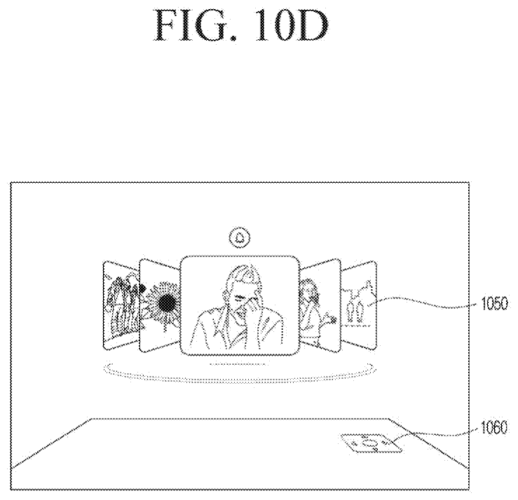

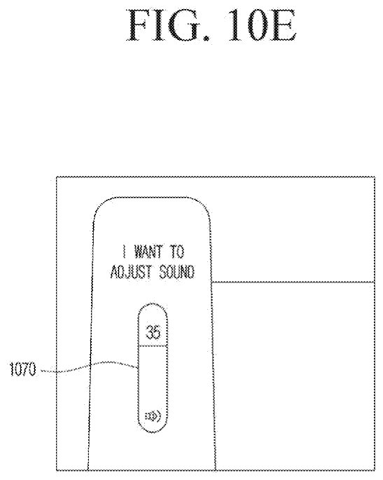

FIG. 10A is a flowchart illustrating a method for identifying the fourth projection region according to an embodiment. FIG. 10B to FIG. 10E are diagrams illustrating a method for identifying the fourth projection region according to an embodiment.

Referring to FIG. 10A, according to an embodiment, the operating method may include identifying a first object from among at least one object based on environment information and information about the third content (S1010).

According to an example, the electronic apparatus 100 may obtain information about the third content. According to an example, the electronic apparatus 100 may obtain information about the third content based on a user input (e.g., user voice input). According to an example, the electronic apparatus 100 may identify, based on at least one from among the information about the third content and the environment information, the first object from among the at least one object in the projection space. According to an example, the environment information may include position information of the at least one object (e.g., plant, desk, sofa, etc.) in the projection space. The electronic apparatus 100 may identify position information in the projection space of the first object associated with the third content and the first object.

According to an embodiment, the operating method may include identifying a region adjacent with the identified first object from among the at least one projectable region as the fourth projection region (S1020).

According to an example, the electronic apparatus 100 may identify a region adjacent with the first object from among the at least one projectable region. According to an example, the electronic apparatus 100 may identify, based on position information of the first object, the fourth projection region from among the at least one projectable region. According to an example, the electronic apparatus 100 may display the third content at the identified fourth projection region.

According to an example, referring to FIG. 10B, the electronic apparatus 100 may display a third content 1010 of a lighting hint type in the fourth projection region. Accordingly, a lighting hint may be lighting for emphasizing an object. According to an example, the electronic apparatus 100 may identify, based on ‘don't forget to water the plant’ being included as information about the third content 1010, a plant 1020 in the projection space and position information of the plant 1020. The electronic apparatus 100 may identify a region adjacent with the identified plant 1020 from among the projectable region as the fourth projection region, and display the third content 1010 at the identified fourth projection region. According to an example, the third content 1010 of the lighting hint type may be content that becomes clearer as the user moves closer to the fourth projection region. The third content may be content in which the blurring effect becomes stronger as the user moves further away from the fourth projection region.

According to an example, referring to FIG. 10C, the electronic apparatus 100 may display a third content (e.g., content 1030) of a UI type in the fourth projection region. For example, content 1030 may be a UI including a text corresponding to ‘it's watering day’ and information about necessary amount of water, but is not limited thereto. According to an example, content 1030 may be displayed in an adjacent region from a plant 1040 which is the identified first object. According to an example, the electronic apparatus 100 may recognize an action of the user based on user posture information, and identify an amount of water currently being supplied based therefrom. The electronic apparatus 100 may also identify the content 1030 based on the identified amount of water.

Alternatively, different from that shown, if the information about the third content includes a ‘washing necessary notification’, the electronic apparatus 100 may identify a level of contamination of clothing present in the projection space, and provide content guiding a position of a washer based therefrom. According to an example, the electronic apparatus 100 may obtain information about clothing present in the projection space from at least one external device (e.g., traveling robot) in the projection space. Alternatively, if the electronic apparatus 100 is implemented as a traveling robot, the electronic apparatus 100 may also directly obtain information about the clothing.

According to an example, a region in which content 1030 is displayed may be a region easily operable by the user or a region with good visibility of the user, but is not limited thereto.

According to an example, referring to FIG. 10D, the electronic apparatus 100 may display a third content (e.g., content 1060) of a UI type in the fourth projection region. For example, it may be assumed that an object 1050 associated with a current music content is displayed in a projection region. The electronic apparatus 100 may display the content 1060 in an adjacent region from the region in which the object 1050 associated with music content is provided. According to an example, the content 1060 may be a UI for operating the music content (e.g., changing order, pausing, playing back, stopping, etc.) but is not limited thereto.

According to an example, referring to FIG. 10E, the electronic apparatus 100 may display a third content (e.g., content 1070) of a UI type in the fourth projection region. For example, it may be assumed that the user is viewing the TV. The electronic apparatus 100 may display content 1070 at an adjacent region (e.g., armrest of sofa) from the position of the TV. According to an example, the content 1070 may be a UI for operating the TV (e.g., changing channels, changing volume, turning-off, etc.), but is not limited thereto.

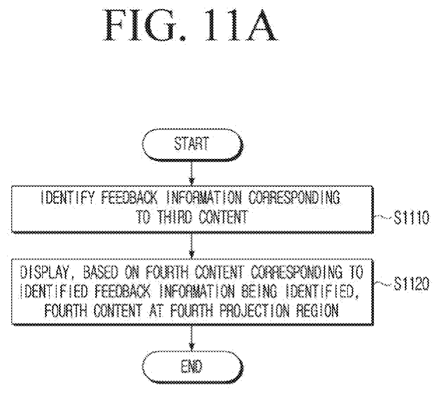

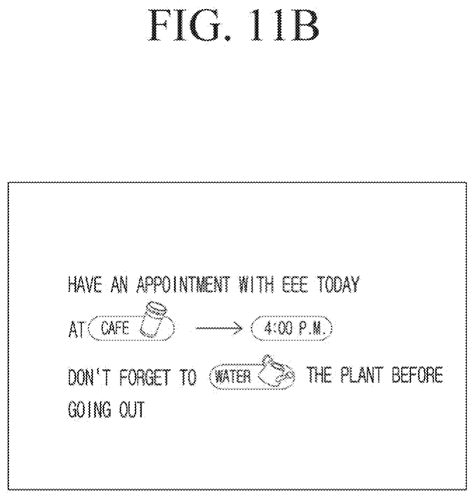

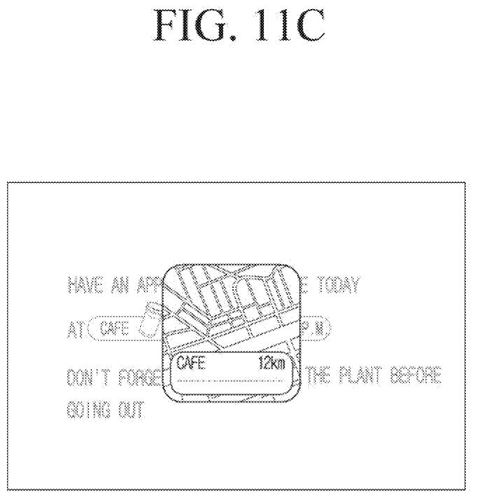

FIG. 11A is a flowchart illustrating a method for displaying a fourth content according to an embodiment. FIG. 11B and FIG. 11C are diagrams illustrating a method for displaying the fourth content according to an embodiment.

Referring to FIG. 11A, according to an embodiment, the operating method may include identifying feedback information corresponding to the third content (S1110).

According to an example, the electronic apparatus 100 may identify feedback information corresponding to the third content. The feedback information corresponding to the third content according to an example may be a user input with respect to the third content. For example, the feedback information may be a user input (e.g., touch input or voice input) for selecting any one from among the at least one sub content included in the third content, but is not limited thereto. Alternatively, for example, the feedback information may be gesture information of the user.

According to an embodiment, the operating method may include displaying, based on the fourth content corresponding to the identified feedback information being identified, the fourth content in the fourth projection region (S1120).

According to an example, the electronic apparatus 100 may identify, based on feedback information being identified, the fourth content corresponding to the feedback information. The fourth content according to an example may be information identified based on user feedback information about the third content, and the fourth content may include at least one of notification information associated with the at least one sub content included in the third content or information about an application corresponding to a sub content.

According to an example, the electronic apparatus 100 may obtain information about the fourth content from an external device based on feedback information. For example, the electronic apparatus 100 may obtain information about an application corresponding to a sub content from at least one of a user terminal or an external server, but is not limited thereto, and the electronic apparatus 100 may also directly generate the fourth content.

According to an example, referring to FIG. 11B, the electronic apparatus 100 may display the third content in a projection region. According to an example, the third content may include notification information associated with a schedule of the user. According to an example, the electronic apparatus 100 may provide notification information of an audio type using a text to speech (TTS) algorithm. According to an example, the electronic apparatus 100 may extract at least one keyword included in the notification information, and generate an image corresponding to the extracted keyword using a pre-set image generation algorithm. According to an example, the electronic apparatus 100 may generate a keyword emphasized image.

According to an example, the electronic apparatus 100 may provide, when having to provide the third content while providing a pre-set content, the content currently being provided and the third content simultaneously. For example, the electronic apparatus 100 may minimize the size of the content (e.g., movie or game) that is currently being provided to a pre-set ratio, and provide the third content in the remaining region.

According to an example, referring to FIG. 11C, the electronic apparatus 100 may identify the fourth content, and display the identified fourth content in the fourth projection region. According to an example, it may be assumed that a user input for selecting ‘cafe visiting schedule’ from among the notification information included in the third content is received. The electronic apparatus 100 may identify a map application as the application corresponding to ‘cafe visiting schedule’. The electronic apparatus 100 may obtain information about the map application from an external device (e.g., user terminal), and identify the fourth content that includes information about a ‘café’ movement route based on the obtained information.

Alternatively, according to an example, it may be assumed that a user input for selecting ‘appointment time’ from among the notification information included in the third content is received. The electronic apparatus 100 may identify a messenger application as the application corresponding to ‘appointment time’. The electronic apparatus 100 may also identify, based on information about the messenger application, the fourth content that includes dialogue content associated with the appointment time.

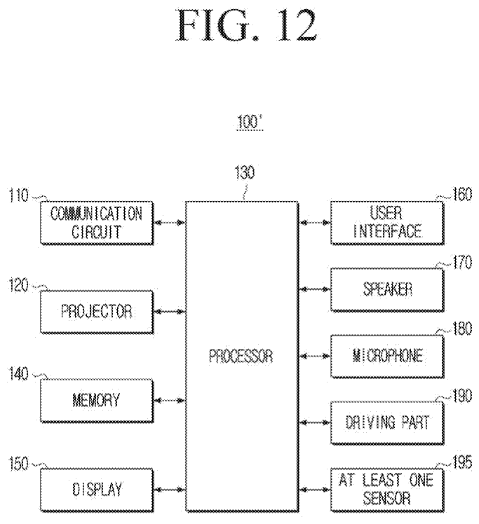

FIG. 12 is a block diagram illustrating a detailed configuration of an electronic apparatus according to an embodiment.

Referring to FIG. 12, an electronic apparatus 100′ may include the communication circuit 110, the projector 120, the at least one processor 130, the memory 140, a display 150, a user interface 160, a speaker 170, a microphone 180, a driving part 190, and at least one sensor 195. Detailed descriptions of configurations that overlap with the configurations shown in FIG. 2 from among the configurations shown in FIG. 12 will be omitted.

The display 150 may be implemented as a display including self-emissive devices or a display including non-emissive devices and a backlight. For example, the display 150 may be implemented as displays of various types such as, for example, and without limitation, a liquid crystal display (LCD), an organic light emitting diode (OLED) display, a light emitting diode (LED), a micro LED, a mini LED, a plasma display panel (PDP), a quantum dot (QD) display, a quantum dot light emitting diodes (QLED), or the like. In the display 150, a driving circuit, which may be implemented in a form of an a-si TFT, a low temperature poly silicon (LTPS) TFT, an organic TFT (OTFT), or the like, a backlight unit, and the like may be included. The display 150 may be implemented as a touch screen coupled with a touch sensor, a flexible display, a rollable display, a three-dimensional display (3D display), a display physically coupled with a plurality of display modules, or the like. The processor 130 may control the display 150 to output an output image obtained according to the various embodiments described above. Here, the output image may be a high-resolution image of 4K or greater than or equal to 8K. The output image may be a game image according to an embodiment.

According to an embodiment, the display 150 may include a plurality of haptic devices. Haptic devices may be implemented as motors for providing haptic feedback (e.g., vibration feedback) to users, but is not limited thereto. According to an example, the display 150 may include haptic devices of a pre-set number. For example, the display 150 may include haptic devices of a pre-set number that correspond to sub regions of a pre-set number in the display, but is not limited thereto, and haptic devices of a number different from a number of plurality of sub regions corresponding to the display may be included in the display.

The user interface 160 may be a configuration for the electronic apparatus 100′ to perform an interaction with the user. For example, the user interface 160 may include at least one from among a touch sensor, a motion sensor, a button, a jog dial, a switch, a microphone, or a speaker, but is not limited thereto.

According to an embodiment, the speaker 170 may be formed of a tweeter for playing back high-range sound, a midrange for playing back mid-range sound, a woofer for playing back low-range sound, a sub-woofer for playing back ultra-low range sound, an enclosure for controlling resonance, a cross-over network dividing electrical signal frequencies which are input in the speaker into bandwidths, and the like.

According to an embodiment, the speaker 170 may output sound signals to outside of the electronic apparatus 100′. The speaker 170 may output playing back of multi-media, playing back of recordings, various notification sounds, voice messages, and the like. The electronic apparatus 100′ may include audio output devices such as the speaker 170, but may include output devices such as an audio output terminal. Specifically, the speaker 170 may provide obtained information, information processed and manufactured based on the obtained information, a response result or operation result for a user voice, and the like in a voice form.

The microphone 180 may refer to a module that obtains sound and converts to an electrical signal, and may be a condenser microphone, a ribbon microphone, a moving-coil microphone, a piezoelectric device microphone, a carbon microphone, or a micro electro mechanical system (MEMS) microphone. In addition, the above may be implemented in an omnidirectional method, a bidirectional method, a unidirectional method, a sub cardioid method, a super cardioid method, or a hyper cardioid method. According to an embodiment, the electronic apparatus 100′ may include the microphone 180 and an inner microphone, and the microphone 180 may be a microphone positioned at a relatively outer side of the body. According to an example, the electronic apparatus 100′ may obtain audio signals that include outside noise through the microphone 180. According to an embodiment, the microphone 180 may be disposed at a direction that is opposite of the direction to which the speaker 170 discharges sound.

The driving part 190 may be a device which can travel the electronic apparatus 100′. The driving part 190 may adjust a traveling direction and traveling speed according to control by the processor 130, and the driving part 190 according to an example may include a power generating device (e.g., a gasoline engine, a diesel engine, a liquefied petroleum gas (LPG) engine, an electric motor, and the like according to a fuel (or an energy source) used) that generates power for the electronic apparatus 100′ to travel, a steering device (e.g., manual steering, hydraulics steering, electronic control power steering (EPS), etc.) for adjusting the traveling direction, a traveling device (e.g., wheel, propeller, etc.) that travels the electronic apparatus 100′ according to power, and the like. Here, the driving part 190 may be modified and implemented according to a travelling type (e.g., wheel type, walking type, flying type, etc.) of the electronic apparatus 100′.

At least one sensor 195 (hereinafter, referred to as a ‘sensor’) may include a plurality of sensors of various types. The sensor 195 may measure a physical quantity or detect an operating state of the electronic apparatus 100′ and convert the measured or detected information to an electrical signal. The sensor 195 may include a camera (or, camera sensor), and the camera may include a lens that focuses visible rays and other optical signals reflected by an object and received to an image sensor, and an image senor capable of detecting the visible rays and other optical signals. Here, the image sensor may include a 2D pixel array that is divided into a plurality of pixels. Alternatively, the at least one sensor 195 may include a temperature sensor or an infrared sensor.

According to the above-described example, the electronic apparatus 100′ may provide, in response to a gesture of the user, an improved multi-media experience to the user by effectively providing content connected with a content that is being provided or to be provided through an external device to match the surrounding environment.

According to an embodiment of the disclosure, the various embodiments described above may be implemented with software including instructions stored in a machine-readable storage media (e.g., computer). The machine may call the stored instructions from a storage medium, and as an apparatus operable according to the called instructions, may include a display apparatus (e.g., display apparatus (A)) according to the above-mentioned embodiments. Based on the instructions being executed by the processor, the processor may directly or using other elements under the control of the processor perform a function corresponding to the instructions. The instructions may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, each of the elements (e.g., a module or a program) according to various embodiments described above may be configured as a single entity or a plurality of entities, and a portion of sub-elements of the above-mentioned relevant sub-elements may be omitted, or other sub-elements may be further included in the various embodiments. Alternatively or additionally, a portion of the elements (e.g., modules or programs) may be integrated into one entity to perform the same or similar functions performed by the respective relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus comprising:
a communication circuit;
a projector;
at least one processor comprising processing circuitry; and
memory storing one or more instructions,
wherein the one or more instructions, when executed by the at least one processor individually or collectively, cause the electronic apparatus to:
based on first gesture information of a user being obtained through the communication circuit, identify a second content corresponding to the first gesture information based on a first content provided through a first external device of at least one external device, and
based on a first projection region associated with the first external device being identified from among at least one projectable region based on environment information corresponding to a projection space, display the second content at the first projection region through the projector.

2. The electronic apparatus of claim 1, wherein the environment information comprises at least one from among position information of each of the at least one external device in the projection space and information about the at least one projectable region, and
wherein the one or more instructions, when executed by the at least one processor individually or collectively, cause the electronic apparatus to:
identify at least one region adjacent with the first external device from among the at least one projectable region as the first projection region based on the environment information, and
identify the second content based on information about the first content obtained from the first external device and position information of the first projection region through the communication circuit.

3. The electronic apparatus of claim 2, wherein the one or more instructions, when executed by the at least one processor individually or collectively, cause the electronic apparatus to
obtain the first gesture information from at least one of a user terminal or a vision sensor, and
the first gesture information is about a gesture obtained from a position within a pre-set distance from the first external device.

4. The electronic apparatus of claim 1, wherein the second content is at least one of a content corresponding to at least a portion of the first content or a content generated based on the first content.

5. The electronic apparatus of claim 1, wherein the one or more instructions, when executed by the at least one processor individually or collectively, cause the electronic apparatus to:
based on trigger gesture information of the user being obtained through the communication circuit, obtain information about the first content from the first external device, and
based on second gesture information corresponding to a second projection region from among the at least one projectable region being obtained through the communication circuit, display the first content at the second projection region through the projector.

6. The electronic apparatus of claim 1, wherein the one or more instructions, when executed by the at least one processor individually or collectively, cause the electronic apparatus to:
based on trigger gesture information of the user being obtained through the communication circuit, obtain information about the first content from the first external device,
identify a third projection region adjacent to the user from among the at least one projectable region based on position information of the user in the projection space, and
display the first content at the third projection region through the projector.

7. The electronic apparatus of claim 1, wherein the one or more instructions, when executed by the at least one processor individually or collectively, cause the electronic apparatus to:
identify a second external device adjacent with the user from among the at least one external device based on at least one from among the environment information and position information of the user, and
provide the first content through the second external device.

8. The electronic apparatus of claim 1, wherein the one or more instructions, when executed by the at least one processor individually or collectively, cause the electronic apparatus to:
identify a third content associated with an artificial intelligence assistant based on context information of the user, and
based on a fourth projection region from among the at least one projectable region being identified, display, the third content at the fourth projection region through the projector.

9. The electronic apparatus of claim 8, wherein the one or more instructions, when executed by the at least one processor individually or collectively, cause the electronic apparatus to:
identify a first object from among at least one object in the projection space based on the environment information and information about the third content, the environment information comprising at least one from among position information of the at least one object and information about the at least one projectable region, and
identify a region adjacent to the first object from among the at least one projectable region as the fourth projection region.

10. The electronic apparatus of claim 8, wherein the one or more instructions, when executed by the at least one processor individually or collectively, cause the electronic apparatus to:
identify feedback information corresponding to the third content, and
display, based on fourth content corresponding to the feedback information being identified, the fourth content at the fourth projection region.

11. A method for operating an electronic apparatus, the method comprising:
based on first gesture information of a user being obtained through a communication circuit of the electronic device, identifying a second content corresponding to the first gesture information based on a first content provided through a first external device of at least one external device; and
based on a first projection region associated with the first external device being identified from among at least one projectable region based on environment information corresponding to a projection space, displaying the second content at the first projection region through a projector of the electronic device.

12. The method of claim 11, wherein the environment information comprises at least one from among position information of each of the at least one external device in the projection space and information about the at least one projectable region, and
wherein the method further comprises:
identifying at least one region adjacent with the first external device from among the at least one projectable region as the first projection region based on the environment information; and
identifying the second content based on information about the first content obtained from the first external device and position information of the first projection region through the communication circuit.

13. The method of claim 12, further comprising:
obtaining the first gesture information from at least one of a user terminal or a vision sensor,
wherein the first gesture information is about a gesture obtained from a position within a pre-set distance from the first external device.

14. The method of claim 11, wherein the second content is at least one of a content corresponding to at least a portion of the first content or a content generated based on the first content.

15. The method of claim 11, further comprising:
based on trigger gesture information of the user being obtained through the communication circuit, obtaining information about the first content from the first external device, and
based on second gesture information corresponding to a second projection region from among the at least one projectable region being obtained through the communication circuit, displaying the first content at the second projection region through the projector.

16. The method of claim 11, further comprising:
based on trigger gesture information of the user being obtained through the communication circuit, obtain information about the first content from the first external device,
identify a third projection region adjacent to the user from among the at least one projectable region based on position information of the user in the projection space, and
display the first content at the third projection region through the projector.

17. The method of claim 11, further comprising:
identify a second external device adjacent with the user from among the at least one external device based on at least one from among the environment information and position information of the user, and
provide the first content through the second external device.

18. The method of claim 11, further comprising:
identify a third content associated with an artificial intelligence assistant based on context information of the user, and
based on a fourth projection region from among the at least one projectable region being identified, display, the third content at the fourth projection region through the projector.

19. The method of claim 18, further comprising:
identify a first object from among at least one object in the projection space based on the environment information and information about the third content, the environment information comprising at least one from among position information of the at least one object and information about the at least one projectable region, and
identify a region adjacent to the first object from among the at least one projectable region as the fourth projection region.

20. A non-transitory computer-readable medium storing one or more instructions, the one or more instructions, when executed by at least one processor of an electronic apparatus, cause the electronic apparatus to:
based on first gesture information of a user being obtained, identify a second content corresponding to the first gesture information based on a first content provided through a first external device, and
based on a first projection region associated with the first external device being identified from among at least one projectable region based on environment information corresponding to a projection space, display the second content at the first projection region through a projector of the electronic apparatus.
